(19) United States
(12) Patent Application Publication
(10) Pub. No.: US 2016/0202903 A1
(43) Pub. Date: Jul. 14, 2016

(54) Human-Computer Interface for Graph Navigation

(71) Applicant: Howard Gutowitz, New York, NY (US)

(72) Inventor: Howard Gutowitz, New York, NY (US)

(73) Assignee: Howard Gutowitz, New York, NY (US)

(21) Appl. No.: 14/994,118

(22) Filed: Jan. 12, 2016

Related U.S. Application Data
(60) Provisional application No. 62/102,110, filed on Jan. 12, 2015.

(51) Int. Cl. G06F 3/0488; G06F 3/0484; G06T 11/20

(52) U.S. Cl. CPC G06F 3/04886; G06T 11/206; G06F 3/0484; G06T 2200/24

(57) ABSTRACT

Human-Computer interfaces for graph navigation are presented. These interfaces are based on swipe-switches and/or crosspairs, perhaps in further combination with keys. The systems operate by parsing a swipe into segments based on crosspairs and/or segment matches to the ideal paths of swipe-switches. Each segment is then used to navigate to a node or along an edge of the graph. Myriad illustrative applications are provided, notably to text input problems, notably in very small devices such as smart watches. It is shown that text-input can be effectively performed by humans using these interfaces, even for complex scripts such as Devanagari and even in smart watches.

### RELATED APPLICATIONS

This application relates to, and claims the benefit of the filing date of the provisional U.S. patent application entitled “Keyboards for Handhelds and Wearables”, application No. 62/102,110 with filing date of Jan. 12, 2015 the entire contents of which are incorporated herein by reference and relied upon for all purposes.

### BACKGROUND OF THE INVENTION

Graphs are important in many aspects of human-computer interaction, and interfaces for navigating graphs are ubiquitous. Examples include cascading drop-down menus, ambiguous keyboards and worldwide web browsers. All of these and many more are mechanism for navigating graphs. In all of these cases, the user needs to select an option among potentially many, and potentially in a hierarchical way, the selection of one option opens to possibility to select sub options, and so on. In some systems, there may be no strict hierarchy, as an option at one level may point back to option at a higher level. A simple graph is a 2-level tree, consisting of a root node, with some edges leading to a second level of nodes, which are terminal nodes: no edges lead from them. An ambiguous keyboard is designed to navigate a tree. For example, on the telephone keypad, one key represents the letters abc, another represents def, and so on. Pressing the abc selects the root node of the “abc” tree, and some further operation, such as pressing the key multiple times, selects an edge leading from the root node, each edge labelled by a letter, a, b, or c. The ambiguous keyboard would typically be coupled to a mechanism which would output the letter to be inserted in a text. So called predictive text system which output a letter after only one press of a key use software to guess which of the edges the user wished to navigate along when they pressed the key. The use of such disambiguation software does not hide the graph nature of the problem, or the graph-navigational-interface character of the ambiguous keyboard. Hierarchical pull-down menus provide a more complex example: trees (or forests) with multiple levels. For example, a “File” menu in a word processing program may have options such as New, Open, Open Recent . . . , Save, Save as . . . , etc. Some of those options may have further options. For example, having selected the root node “File” and the edge labeled “Open Recent” the user arrives at a new node and a new set of options (edges in the graph), in this case being a list of recently opened files available for re-opening. A web browser is a graph navigation apparatus adopted to a still more complicated graph, the world wide web. Each node in that graph (web page) contains one or more links (edges) pointing to still other nodes, not necessarily in a hierarchy, and potentially with loops.

Not only is there a very large variety of graphs to be navigated, there is a very large variety of computational devices on which such graphs are presented to the user for navigation. They may be very small, such as in the 2-D screen of smart watch, or large, such as a 3-D gaming system (such as the Nintendo Wii system), or some immersive virtual reality system sensitive to wholebody movements and able to use those movements for graph navigation, or larger still where the system is sensitive to movements of vehicles, etc.

A fundamental problem addressed here has not been considered until now, let alone solved: How to make easy-to-use graph navigation systems, capable of handling a wide variety of graph structures, which are scalable enough to be implemented in a smart watch or a gigantic virtual reality playground and yet be similar enough such that skills learned by using the graph navigation system of the smart watch are transferable to graph navigation in the virtual reality playground?

Below, after illustrating what we mean by certain terms used to describe the various embodiments, we will describe those embodiments, in illustrative applications to small and large devices, simple and more complex graphs to navigate. For the sake of concreteness, we will often refer to touch-screen devices, and describe embodiments in terms of key data (touch up and touch down, or key up and key down) and swipe data (gesture paths, swipe paths), terms especially known in the context of touch screens. However, these references are understood to be illustrative and non-limiting. A “touch down” event might be represented in a 3-D virtual reality system by the clenching of a fist, the clapping of hands, or some other system-appropriate gesture, and likewise for touch-down events, swipe paths, and the like.

In some embodiments the symbols to be typed can be selected by taps or sequences thereof. Embodiments in which symbols are entered using taps alone might be materialized using a wide variety of hardware sensitive to taps, such as traditional mechanical keys. In other embodiments, symbols may be selected by swipes. These latter embodiments comprise hardware sensitive to swipe gestures, such as touch screens. The swipes gestures might occur in the air in front of or otherwise near the screen, or involve movement of the entire device, employing movements familiar from gaming devices such as the Nintendo Wii, depending on the sensors available to detect movement. Though, for the sake of concreteness, we will often refer to touch-screen devices, the implementation with whole-device gestures or near-device gestures should be evident to a person skilled in the art.

### BRIEF DESCRIPTION OF THE DRAWINGS

The various aspects and features of the invention will be described in reference to a set of drawings, brief descriptions of which follow.

FIG. 1A FIG. 15 from the '156 patent, an embodiment comprising letters in alphabetic order around a circle, operated with buttons and swipe-switches.

FIG. 1B FIG. 16A from the '156 patent, showing the pre-input state resulting from pressing key of FIG. 1A.

FIG. 1C FIG. 16B from the '156 patent, showing the pre-input state resulting from pressing key of FIG. 1A.

FIGS. 2A-D The embodiment of FIGS. 1A-B modified such that all letters may be input using swipe-switches, possibly in combination with a prediction and correction module. FIG. 2A: Schematic indicator of swipe directions. FIG. 2B: Keyboard incorporating the swipe direction indicators. FIG. 2C: Pre-input state resulting from pressing ABCDEF key, and ideal paths for swipe-switches. FIG. 2D: Pre-input state resulting from pressing GHIJKL key, and ideal paths for swipe-switches.

FIGS. 3A-B An illustrative embodiment of a keyboard based on swipe-switches, with piecewise alphabetic ordering, groups of at most 3 symbols, and other features. FIG. 3A: keyboard layout with central display. FIG. 3B: Ideal paths and associated regions for a representative group of 3 symbols.

FIGS. 4A-C An embodiment like that of FIGS. 3A-B, but on a shape conformably mappable to a circle. FIG. 4A: Base state. FIG. 4B: Pre-input state for input of a, b, or c. FIG. 4C: Pre-input state for input of s, t, or u.

FIGS. 5A-D Illustrative examples of piecewise alphabetic ordering. FIG. 5A: clockwise (intraand inter-)group top half, clockwise inter-, counterclockwise intra-group bottom half. FIG. 5B: same as FIG. 5A, but clockwise intragroup, and with reflection in bottom half. FIG. 5C: top half same as that of FIG. 5A, but bottom half is counterclockwise both inter- and intra-group. FIG. 5D: same as FIG. 5C as far as orientation, but symbols are grouped following a telephone keypad grouping.

FIGS. 6A-B Piecewise typewriter keyboard ordering. FIG. 6A: Piecewise preservation of conventional row orientation and ordering. FIG. 6B: Piecewise preservation of conventional row ordering.

FIGS. 7A-B Operation of the device of FIG. 6B. FIG. 7A: Base state. FIG. 7B: Pre-input state for the group qwert.

FIGS. 8A-G FIG. 8A: Base state. FIGS. 8B-G: Swipe directions for the pre-input state of each group.

FIGS. 9A-C Concatenation of swipe segments. FIG. 9A: Using swipe-switches. FIG. 9B: Single crosspair. FIG. 9C: Two crosspairs.

FIG. 10 Flow chart for the detection of crosspairs and their use in graph navigation.

FIG. 11 Comparison of swipe-switches and crosspairs.

FIGS. 12A-B A text-input system based on crosspairs. FIG. 12A: Pre-input state for the group ABC. FIG. 12B: Pre-input state for the group DEF.

FIG. 13 Use of a text-input system based on crosspairs.

FIG. 14 Animation for teaching the operation of a device based on swipe-switches or crosspairs.

FIG. 15 Auxiliary display and its uses.

FIGS. 16A-D Animation of an efficient path corresponding to an actual swipe. FIG. 16A-D: Snapshots over time.

FIGS. 17A-D Enhancement of an auxiliary display. FIG. 17A-D: Snapshots over time.

FIGS. 18A-D Variable shape segment highlights for systems based on crosspairs. FIG. 12A-D: Snapshots over time.

FIG. 19 An illustrative device based on both swipe-switches and crosspairs.

FIG. 20 An illustrative application to an image classification problem.

FIG. 21 Further illustration of an image classification problem.

FIGS. 22A-C Introduction to L- and T-shaped swipes. FIG. 22A: Base state. FIG. 22B: Crosspair segment followed by annular swipe segment. FIG. 22C: Potentially further followed by a second crosspair segment, so as to input an accented letter.

FIG. 23 Illustrative application to text-input using Devanagari script.

FIGS. 24A-B A illustrative use of L-shaped swipes for Devanagari input. FIG. 24A: Crosspairs for Devanagari. FIG. 24B: Crosspair followed by an annular swipe for Devanagari.

FIGS. 25A-F Introduction to L- and T-shaped swipes with length classes. FIG. 25A: A crosspair. FIG. 25 B: A crosspair segment followed by a long counter-clockwise annular segment. FIG. 25C: A crosspair followed by a short, clockwise annular segment. FIG. 25D: A crosspair followed by a short clockwise annular segment and a long counterclockwise annular segment. FIG. 25E: A crosspair followed by a short clockwise annular segment and a short counter-clockwise annular segment. FIG. 25F: A crosspair followed by two short annular segments and a long annular segment.

FIG. 26 An illustration of the possible co-existence of keys and crosspairs.

FIG. 27 An illustrative application to Japanese. FIG. 27A: full labeling. FIG. 25B: Abbreviated labeling particularly suitable for a watch face.

FIG. 28 Identification of crosspairs in the face of human error.

### DETAILED DESCRIPTION

We will now describe in detail a sequence of embodiments each concerning an apparatus, which is a human-computer interface for navigating graphs comprising 1) a path generator for generating finite paths through 2-dimensional space under direction of said human; The path generator might for instance be a finger swiping a path on touch screen, a hand moving through the air in a virtual reality or gaming system, or guiding a computer mouse. 2) a piece-wise continuous shape, the closure of which is conformally mappable to a circle. The simplest example is a circle or a sphere, or any shape with one hole which is conformally mappable to a circle or sphere. The shape could be conformally flat, e.g. a line in 2-D or a plane in 3-D, where the flat shape is to be considered a finite part of an infinite circle or sphere, such that e.g. above the line is “outside” and below the line is “inside” the shape. 3) A parameterization of the closure of said shape. The surface of any such shape admits some parameterization. For the circle, degrees of arc from a reference point on the circle is an example parameterization. 4) a piecewise alphabetic or mechanical typewriter ordering of symbols around said shape, such that each piece Oᵢ of said piecewise ordering corresponds to a piece Pᵢ of said parameterization, which is in turn associated with a piece Sᵢ of said closure of said shape. Roughly speaking, symbols can be ordered around the shape, following increasing values of the parameterization and following, in whole or in part, the order given by some convention such as alphabetic ordering, the ordering of a syllabic table, or the ordering along the rows and/or columns of the keys of a mechanical typewriter. 5) for each Oᵢ, at least one associated swipe-switch SSᵢⱼ whose ideal path begins at or near said associated Sᵢ and pointing towards the interior of said closure of said shape, each SSᵢⱼ associated with one or more symbols from Oᵢ. The ramifications of this limitation will become clear via the detailed examination of various illustrative embodiments. 6) A matching mechanism for matching actual swipes performed by said human to an ideal path of one of said SSᵢⱼ such that when said human performs a swipe W beginning at or near Sᵢ said matching mechanism will match W to a matched SSᵢⱼ associated to Si, and then said symbol or symbols associated to said matched SSᵢⱼ will be output. This matching mechanism is described in detail in U.S. Pat. No. 9,189,156 B2, entitled “Keyboard comprising swipe-switches performing keyboard actions” to the present inventor, with PCT filing date Jul. 14, 2010, and issued Nov. 17, 2015 which is hereby incorporated by reference in its entirety and relied upon for all purposes, and will hereinunder be referred to as “the '156 patent”, and figures from that patent referred to as '156:FIG. (FIG. number). In this present disclosure, we will rely in particular on the descriptions provided in the '156 patent of certain elements employed in various embodiments described below, notably but not limited to swipe-switches, their ideal paths, and mechanisms to match actual finite paths generated by humans to said ideal paths.

Though many of the illustrative embodiments we will describe in detail are text input systems, text input is part of a broader class of graph navigation problems. Even for complex scripts, such as Devanagari, text input is equivalent to the navigation of a particular class of relative simple graphs, simple at least when compare to the graphs underlying finite-state machines. Already in the case of text input, but also in the case of navigation of a broader class of graphs, it is desirable to allow the user to navigate though several nodes of the graph in succession using a single continuous gesture. While machines allowing this can be built with swipe-switches, another way of matching swipe gestures by a human to actions taken by a computer can be helpful, alone or in combination with swipe-switches and their associated swipe-matching machinery. This involves a novel system which we will call a crossing detector, capable of detecting the crossing of a swipe path through a shape, the direction of such cross (from outside to inside or vice versa) and capable also of matching an outside-to-inside cross with an immediately following inside-to-outside cross, and thus recognize a so-called crosspair segment or crosspair for short. These crosspairs can play roles similar to swipe-switches, could be used in parallel with or in addition to swipe-switches (or regular switches for that matter) but have the advantage in some circumstances of being more easily concatenated one after the other. More particularly, we will present embodiments illustrating a human-computer interface for navigating graphs comprising 1) a path generator for generating paths through n-dimensional space under direction of said human; 3) a shape of dimension m<=n through which said paths can traverse; 4) a parameterization of said shape; 5) a crossing detector which detects when paths generated by said path generator cross the surface of said shape by entering or exiting said shape, and computes the parameter values of the positions at which said entering or exiting occurs, said crossing detector generating electromagnetic signals representing detected crosses, communicating said signals for further graph navigation processing; 6) given a graph to be navigated by said human using said interface, said graph comprising nodes and edges connected said nodes, a mapping of each navigable node of said given graph to a first range of values in said parameterization, and a mapping of each navigable edge from said each navigable node to a second range of values of said parameterization, said second range contained completely within the complement of said first range of values in said parametrization; 7) a navigator, which receives signals from said crossing detector, and uses said signals to navigate said given graph in consultation of said mapping, such that when said crossing detector detects a crosspair, said crosspair being the entrance of said path in a region of said shape corresponding to said first range, followed by an exit of said path in said second range, with no intervening crosses detected by said crossing detector, then said navigator will navigate in said given graph from said node corresponding to said first range along said edge corresponding to said second range.

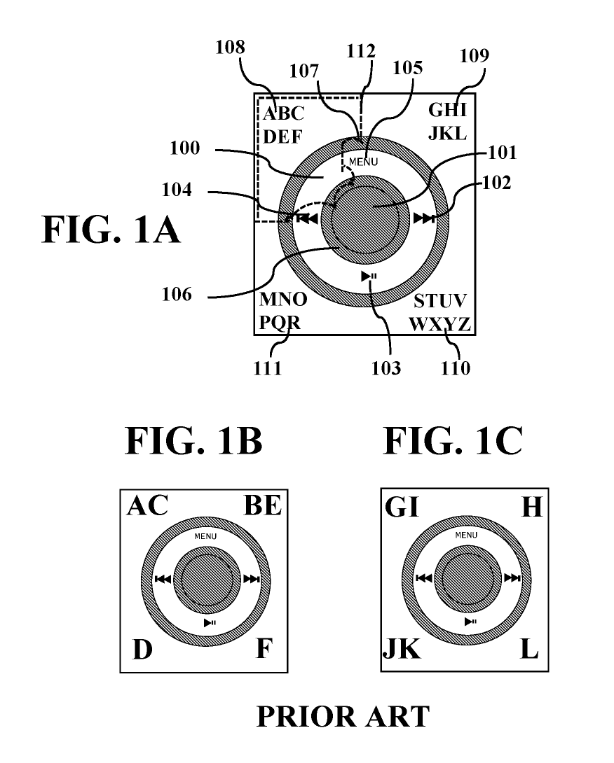

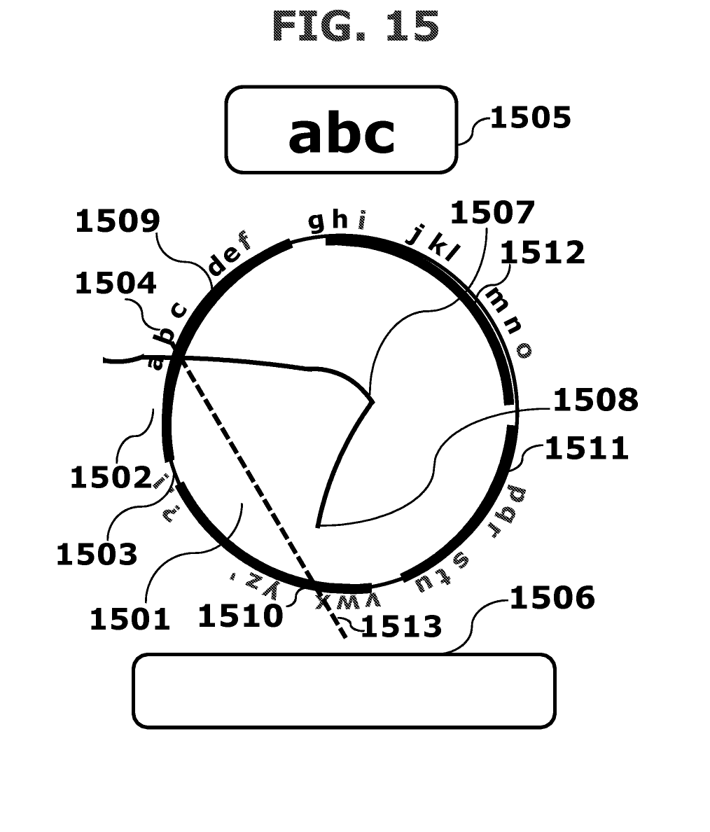

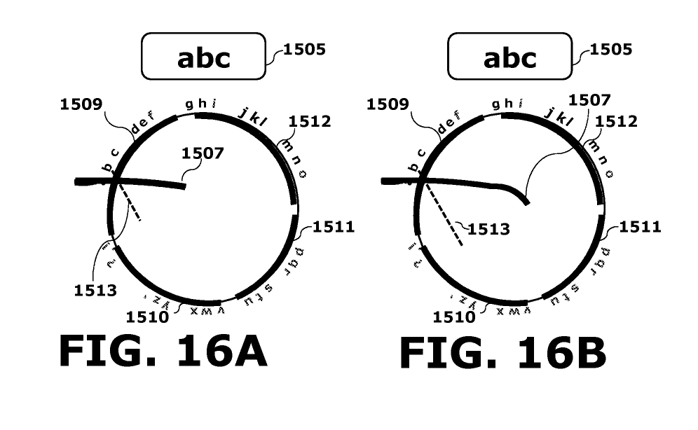

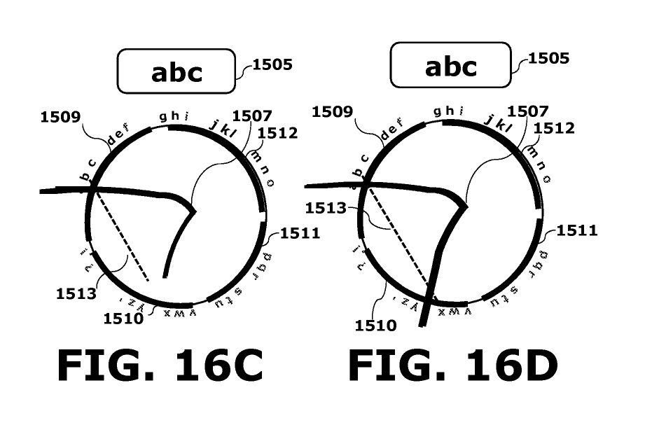

The first illustrative embodiment to be taught in detail will be discussed first in reference to FIGS. 1A-C each panel of which is taken from the '156 patent, specifically '156:FIGS. 15-16. We will then proceed to modify those panels to point out some features of some of the present claims. FIG. 1A shows an apparatus comprising swipe-switches, keys, symbols (letters A-Z) arranged in piecewise alphabetic order around a shape [107] which is conformally mappable to a circle, indeed is a circle, and which has a continuous closure which is a circle, which apparatus can be used for text input, among other functions. In particular, [100] is a swipe control, [101]-[105] are keys (aka “buttons”), and [106]-[107] are swipe-switches. Four further keys [108]-[111] are use for text entry. These are large keys, overlapping the ideal paths of the swipe switches. For example the “receptive field”, the area in which the key may be activated by tapping, is shown in the case of [108] by a dotted line [112]. To input a letter, one first presses which ever key in [108]-[111] is labeled with the intended letter, creating a pre-input state. The letters from the selected key are then distributed over the 4 keys [108]-[111] which now contains the letter. For selection of some letters, e.g. B or E, the selection is still ambiguous, since B and E occur together in a pair. In this case, a prediction and correction module will be activated to guess which of the letters, B or E, was intended to be input by the user, and input of that letter will follow. FIG. 1B (from '156:FIG. 16A) shows the pre input state created by pressing key [108], and FIG. 1C (from '156:FIG. 16B) shows the pre-input state created by pressing key [109].

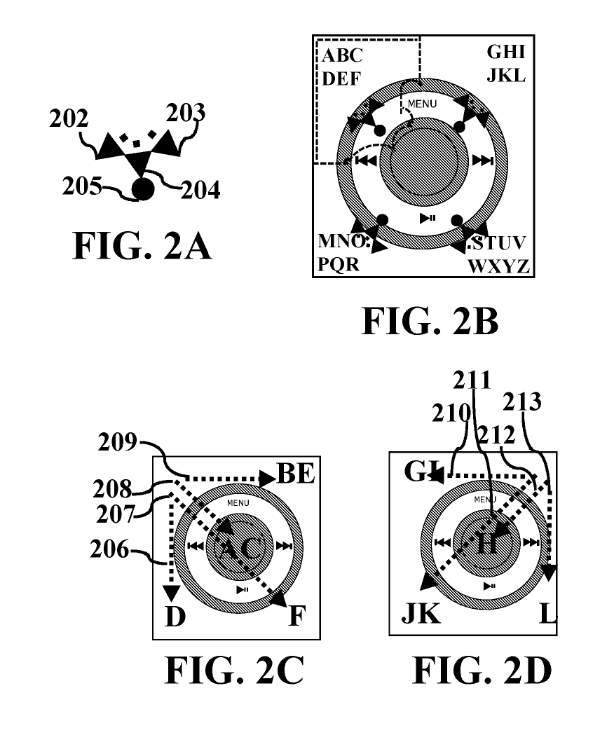

Turning now to FIGS. 2A-D, we will modify the embodiment of FIGS. 1A-C such that letters, or groups of letters in the case of the ambiguous keys, can be input using swipe switches rather than pairs of key touches. The first touch of a pair will remain the same as before, but the second touch will be indicated by a swipe nearly along the ideal path of a swipe-switch pointing to the second key. It is to be noted that in embodiment of FIGS. 1A-C, the second key in a pair corresponding to a given letter may be identical to the first key in the pair. This is the case, e.g. for the letter A, which is input by first pressing key [108] to create a pre-input state in which AC is on key [108] and then pressing [108] again. A system could be created where such letters are still input by double taps, but swipe-switches used for other cases. However for didactic reasons, we seek now to create an embodiment in which all letters are input with swipe-switches. Accordingly, in the embodiment of FIGS. 2A-D, we will modify the pre-input state so that every letter can be swiped to along some ideal path. To help the user understand on the embodiment of FIGS. 2A-D operates, we provide each text-input key with an indicator showing the directions in which swipes are to be performed to activate swipe-switches. That is, they indicate the direction of the ideal path of the swipe-switches. This indicator, shown in FIG. 2A, has for components [202]-[205], each conveying information as to how swipes in the pre-input state resulting from pressing the key are to be performed. [202] is a mini-arrow pointing down and to the left, [203] is a mini-arrow pointing down and to the right, [204] is a mini-arrow pointing down, and [205] is a representation of a center circle to be swiped toward. FIG. 2B shows each of the 4 input keys labeled with an indicator in the appropriate orientation. Other than these indicators, FIG. 2B is identical to FIG. 1A, though part labels have been suppressed for clarity. FIG. 2C shows the pre-input state which results when the ABCDEF key (key [108] of FIG. 1A) has been pressed. The letters which would have appeared on the same key in the embodiment of FIGS. 1A-C, in this case, the letters AC, now appear in the center disk. The swipe path to be swiped along to input letters A or C is indicated in FIG. 2C as the dotted arrow [208]. Similarly, swiping along ideal path [206] inputs the letter D, [207] the letter F, and [209] the letters B or E. FIG. 2D is the same as FIG. 2C, except in this case the GHIJKL key (key [109] of FIG. 1A) has been pressed, producing the pre-input state shown. Swipes along the ideal paths [210]-[213] input the letters, or letter pairs, GI, H, JK, and L respectively. As always, in the case of ambiguous input at this step, a prediction and correction algorithm (disambiguation software) can be applied to select one of the letters from the ambiguous pair. Keys MNOPQR and STUVWXYZ behave similarly (not shown).

We will consider in the next illustrative embodiment limiting the number of symbols in a group (piecewise segment of an ordering) to 3. We will also see to it that in this embodiment a) swipe-switches used to input symbols all have a start region at or near the circle (more generally a shape whose closure is conformal to a circle) around which the symbols are ordered, b) that the swipe-switches of a) are sufficient to input all the symbols (including the letters A-Z), that c) there are no swipe-switches whose ideal path begins in the interior of the shape, pointing towards or though the boundary of the shape, and such that d) there is a functionally distinct swipe-switch for each symbol to be input. That is, we will create this embodiment such that every symbol is has its own swipe-switch which can be (easily) distinguished by the mechanism which matches actual swipes to ideal paths from all other such swipe-switches and their ideal paths.

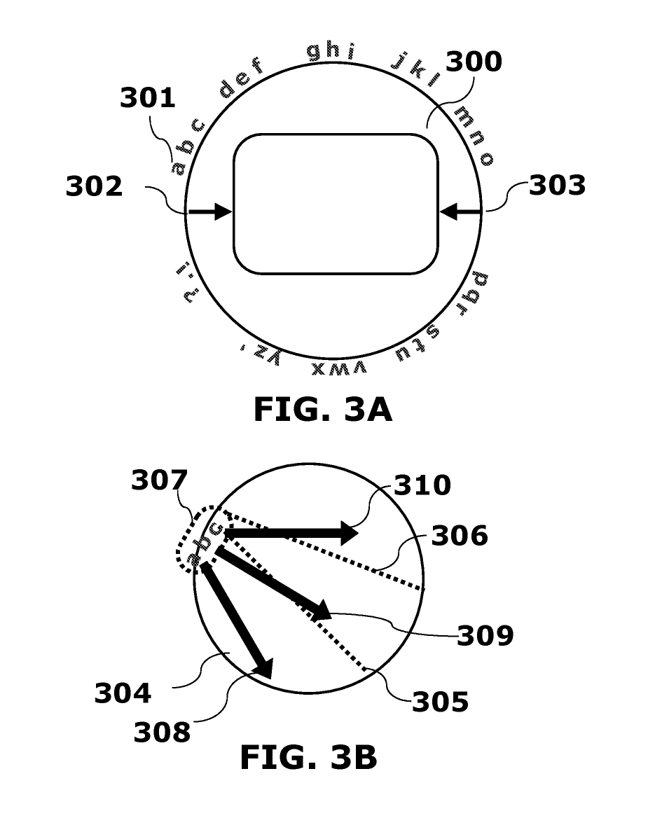

To illustrate some of the implications of these limitation, we turn to FIGS. 3A-B. FIG. 3A shows a display [300] for displaying text entered at the keyboard [301]. Since, as will be appreciated more fully below, the interior of the shape contains no swipe-switch starting regions, facilitating the unencumbered display of text in the display [300]. The keyboard [301] is a piecewise alphabetically ordered arrangement of letters around a circle, with 12 groups of letters and/or other symbols. Illustratively each group is placed at a clock points, that is, the typical positions of numerals in a circular 12-hour clock. Each group contains three letters or other symbols, except for the singleton groups [302] and [303] which, when the associated swipe-switch is swiped, produce the symbols space and backspace respectively. In this illustrative example, the letters are fully alphabetic order, not just piecewise alphabetic order. That is, the letters are arrange alphabetically both within and between groups. FIG. 3B focuses in on the group abc as representative of all of the groups. A swipe from the start region [307] through the regions [304]-[306] produces the letters a, b, and c respectively. This is because there is an ideal path [308]-[310] for swipe-switches in each of the regions [304]-[306] respectively, associated to the letters a, b, and c respectively. Note that an actual swipe may wander from the indicated region and still be matched to the ideal path within the region. The regions simply indicate that an actual swipe path which remains throughout its duration in the region is likely to be matched to the ideal path in the region. Each other group of 3 symbols in the keyboard [301] has the same structure of regions and swipe-switches as that shown for the group abc in FIG. 3B. This rule has a simple description: swipe left (from near the boundary of the shape toward the inside of the shape) for the left letter, right (from near the boundary of the shape towards the inside of the shape) for the right letter, and from near the boundary directly through the inside of the shape for the middle letter. The regions for each of the other groups are obtaining by rotating the regions of FIG. 3B accordingly around the center of the device. For the singleton groups [302] and [303] either of two rules may be adopted: 1) swipe directly across the inside of the shape for space and backspace respectively or 2) swipe in any direction from the respective start regions towards the inside of the shape for space or backspace respectively.

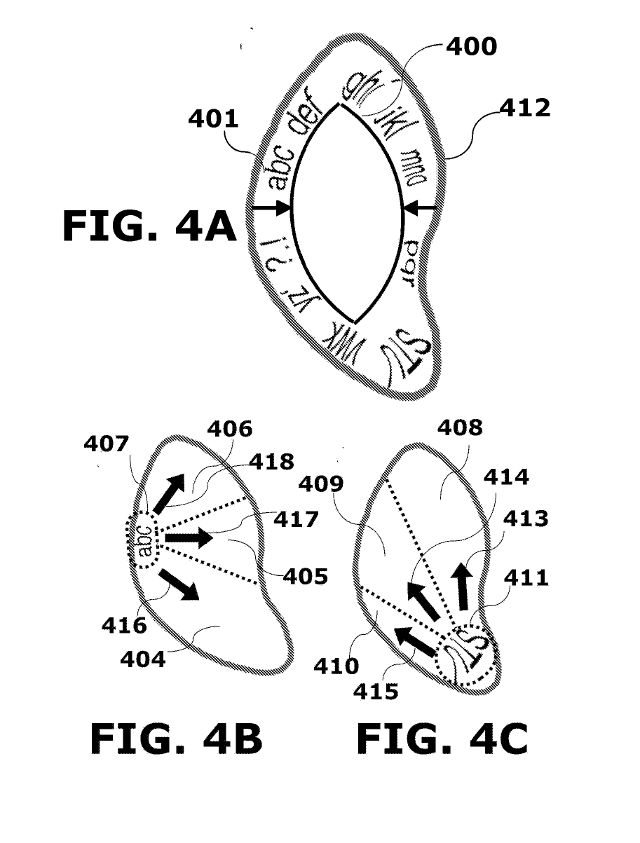

Note carefully that we used an exactly circular shape for the illustrative embodiment of FIGS. 3A-B. However, any shape which can be conformally mapped to a circle in 2 dimensions (or a sphere in 3 dimensions) can play the role of the circle in FIGS. 3A-B. This broad class of shapes includes the shape of any common manufactured item, includes regular and irregular polygons, etc. We draw claims to a still broader class of shapes by considering rather than the shape itself, its closure. This allows us to consider shapes which are piecewise continuous but have gaps. Concretely, think any shape which could be drawn as one non-intersecting line, using a pen which occasionally skips. We will in this disclosure often refer indifferently to a shape, its closure, and a parameterization of the boundary of the closure. Referring to the parameterization of the boundary of a shape is particularly useful when discussing the intersection of a path with a shape. The intersection point corresponds to some value of the parameterization. For instance, “clock points” on an arbitrary closed Bezier curve can be approximated by the points t=0, 1, . . . , 11, when the curve is parameterized so that the parameter t runs between 0 and 12 around the curve, starting at the positive x axis. In a product built according to these embodiments, especially one with a decidedly non-circular shape, the clock points might be adjusted for aesthetic reasons, to ensure functional distinctness of any swipe-swipes or distinguished ranges of parameters associated to the clock points. As an illustrative example consider the shape used in the embodiment of FIGS. 4A-C. This embodiment operates in the same way as the embodiment of FIGS. 3A-B, apart from the distortion of the circle of FIGS. 3A-B into this somewhat arbitrary shape [412]. Referring to FIG. 4A, we see that the shape [412] is associated with a keyboard [401], which is functionally the same as [301] of FIG. 3A, the differences being that here the keyboard follows along with the distorted contour of the shape, and the symbols are labelled within the shape, though still near the shape, permitted the associated swipe-switch start regions to remain near the shape, in a way which is clear to the human user. The embodiment of FIGS. 4A-C incorporates an inner void [400] which can be used, for example to display text generated using the keyboard [401]. FIG. 4B is analogous to FIG. 3B, in that it shows how letters from the group abc are input, using swipe switches whose ideal paths are indicated by [416]-[418], each starting from the start region [407], via interior regions [404]-[406] respectively, and inputing letters a, b, and c respectively. FIG. 4C further illustrates the effects of using a non-circular shape. Here, swipe-switches with ideal paths indicated by [413]-[415] and starting at region [411] input letters s, t, and u respectively by capturing swipes starting at or near the start region [411] and passing though regions [408]-[410] respectively.

Piecewise Alphabetically Ordering

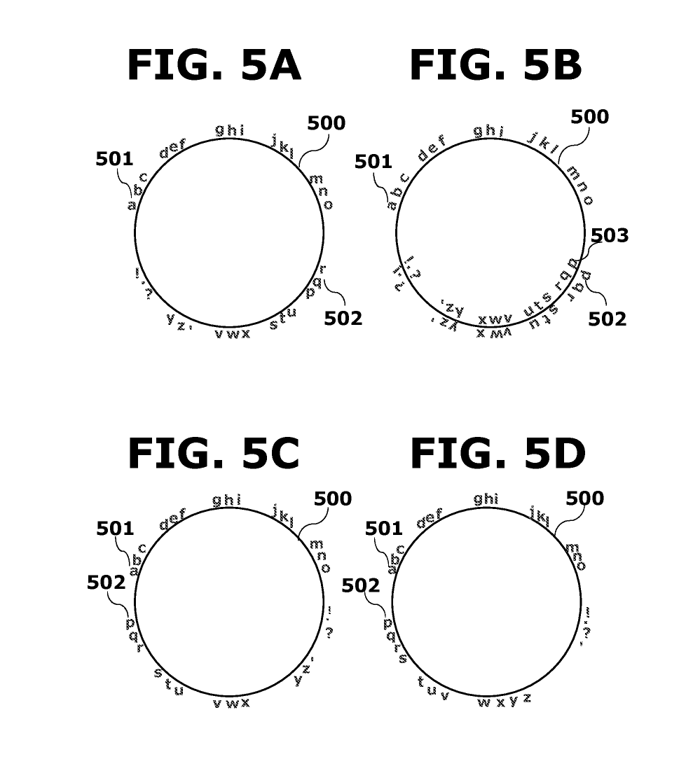

Latin script, used to write English among other languages, has a linear alphabetic order. In a piecewise alphabetic ordering as described herein, letters may be grouped together along a shape so that the letters increase or decrease in that order with respect increase of parameter values in the parameterization of a shape. Other scripts, such as Devanagari, do not have a natural linear order, but rather a two-dimensional tabular structure. The tabular structure may be reduced to a linear order by, e.g., unicode collation rules. We will see further on that we can respect tabular structure using a piecewise ordering. The same techniques allow us piecewise map tabular orderings given by the layout of a mechanical keyboard to linear variation of parameter values in a parameterization of (the boundary of) a shape. Before discussing these techniques, we present, in reference to FIGS. 5A-D, some illustration of how piecewise alphabetic orderings may differ from one another even with a linear script such as Latin. FIGS. 5A-D, to which we now turn, present a sampling of grouping and ordering of the letters a-z around a circle. In each of the panels of FIGS. 5A-D, a different illustrative choice is made regarding application of alphabetic ordering within and between groups, and in relationship of that ordering to direction with respect to the parameterization of the shape. Numerous choices other than those shown here may be made within the scope of piecewise alphabetic ordering. In particular, though pieces of 3 or 4 symbols are shown in FIGS. 5A-D, symbols could be grouped into pieces of any number of symbols. The ordering might associate the reading order of the script with increasing or decreasing parameter value on the shape, and do so differently for each group of symbols, or only for some groups of symbols. Only a few examples from that large set of variations is shown in FIGS. 5A-D. Each of the panels of FIGS. 5A-D show a parameterized shape [500] and a keyboard with at least two distinguished parts [501] and [502]. In FIG. 5A, the letters are arranged generally clockwise in groups, starting with letter a in [501]. However, in [502] the letters proceed in alphabetic order counter-clockwise within the groups, though the groups as a whole continue in alphabetic order clockwise. Contrast this with the arrangement FIG. 5B, in which the letters around the whole circle in clockwise alphabetic order. Further, in FIG. 5B, the baseline of each letter is tangent to the shape of the device, while in FIG. 5A, the letters are all upright. Further still, the letters in the bottom half of the device [502] each have a duplicated and transformed version [503]. The indicated transformation is a rotation, but could also be a reflection, a shadow or some other transformation. In FIG. 5C, the letters proceed alphabetically clockwise both within and between groups in [501], and then in [502] proceed alphabetically counter-clockwise both within and between groups. In FIG. 5D, the symbols are oriented and sequenced similarly to FIG. 5C in both [501] and [502] but are grouped differently, here according to the letter groupings of the 12-key telephone keypad for English.

Piecewise Typewriter Ordering

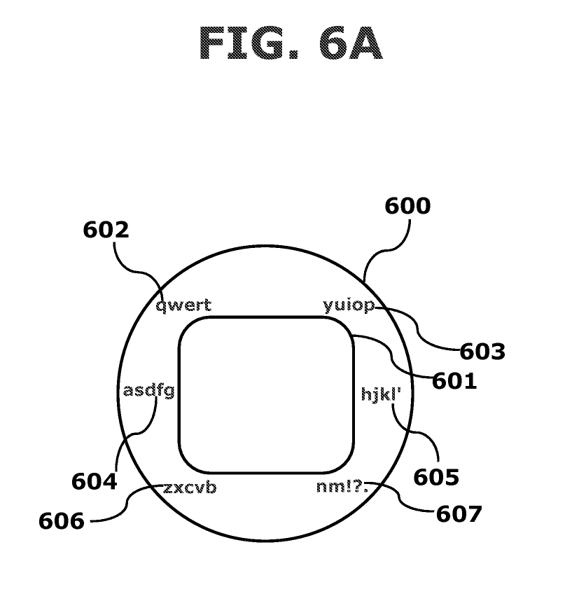

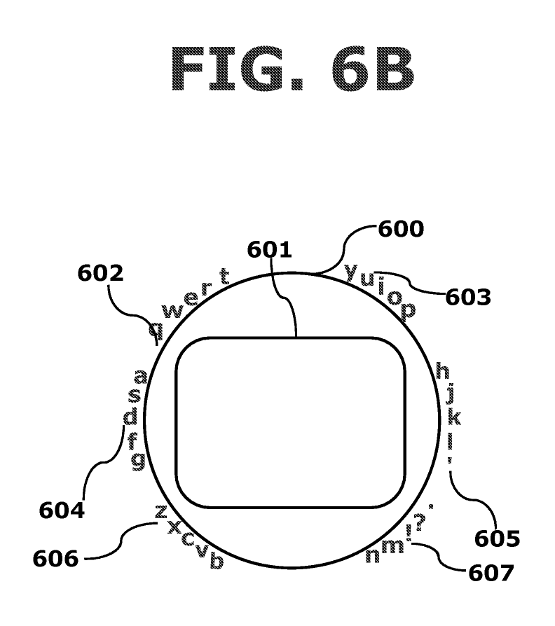

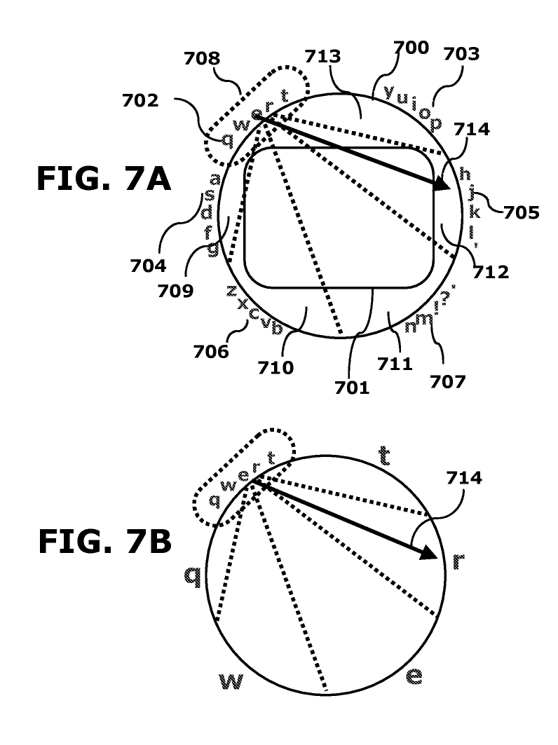

Another source of ordering is to be found in reference to typewriter keyboards. Typewriter keyboards conventionally comprise rows and columns of keys, and an order of symbols can be read off from these rows and/or columns, and incorporated into a keyboard in a device according to the present teachings. An illustrative example is embodied in the device of FIGS. 6A-B to which we now turn. The ordering of letters in the keyboard of FIGS. 6A-B is derived from the Qwerty keyboard used to write English, though any conventional keyboard for a mechanical typewriter, used to write languages other than English and scripts other than Latin, can be used to supply a piecewise typewriter keyboard ordering. Each of FIGS. 6A-B show a shape [600] with an interior void containing a display [601]. Around the display are arranged pieces of a Qwerty keyboard, respecting the ordering of letters on that keyboard. [602], [603] are the left, right respectively halves of the top row of the Qwerty keyboard, [604], [605] the left, right respectively halves of the middle row of the Qwerty keyboard, and [606], [607] are the (approximately) left, right respectively halves of the bottom row of the Qwerty keyboard, where in the case of [607] certain punctuation symbols have been preferably added to such the typewriter-ordered letters such that each group [602]-[607] contains the same number of symbols. An implication of this will be discussed below in relationship to FIGS. 7A-B. FIG. 6A illustrates piecewise preservation of both conventional row orientation and ordering. That is, the letters follow each other horizontally, like in the original mechanical keyboard. However in FIG. 6B, the groups [602]-[607] have been oriented along the shape [600] so that varying the parameter value of the shape's parameterization changes the letter which is referenced by that parameter value, “referenced” in the sense that the label of the letter is located nearest some point on the boundary of the shape with a given parameter value. Note that rather than reading across rows, we could have read along columns. E.g. from the Qwerty keyboard we might derive the groups qaz, wsx, edc, and so on. We could have used some other mechanical keyboard layout as a basis, could have sized, ordered and augmented the pieces with symbols differently and so on, all well within the scope of these present teachings.

Operation of Piecewise Typewriter Ordered Keyboard Using Swipe-Switches

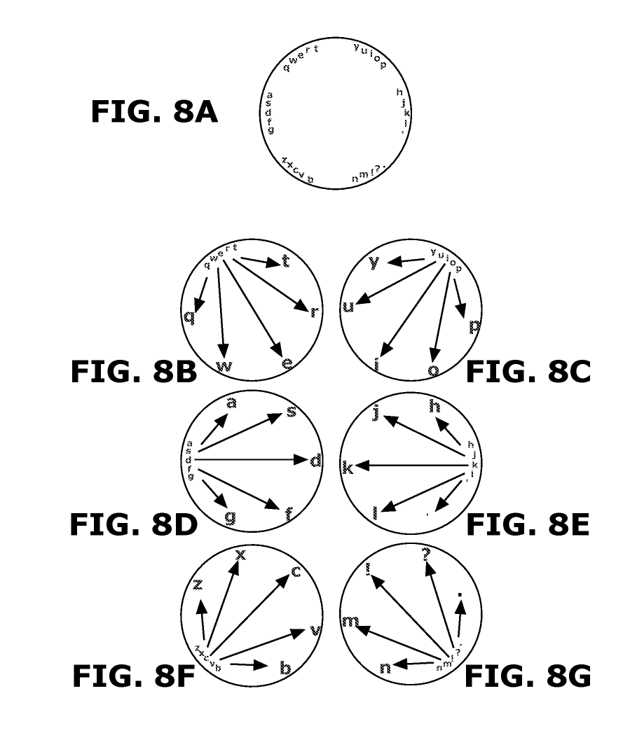

FIG. 7A shows the arrangement of a shape [700], a display [701] and a keyboard [702]-[707] seen previously in FIG. 6B. To explain how this embodiment works as an input mechanism, we will focus first on the group of letters qwert [702], here arranged in piecewise typewriter ordering, going clockwise around the shape [700], which is to say in increasing order of parameter value in the typical parameterization of a circle based on angle or path length. Letters from the other groups can be entered in the same way, as will be appreciated more fully below in reference to FIGS. 8A-G. About [702] is a region roughly indicated by the closed dotted line [708]. Swipes which input any of the letters q, w, e, r and t begin in that region with a key-down event, creating a pre-input state for any of the letters qwert. Which of those letters will be input depends on the direction of the swipe towards the interior of the shape [700] and away from the start region [708]. The swipe could continue through any of the regions [709]-[713]. In each region there is an ideal path for a swipe switch, so that a swipe nearest a given ideal path will activate the corresponding swipe-switch. For clarity only one of these is shown [714] in region [712]. If an actual swipe is matched to this swipe-switch, then the letter r will be input. This situation is further clarified in FIG. 7B, which duplicates part of FIG. 7A, leaving aside various elements such as reference numbers and lead lines, and showing instead of the base state labeling [702]-[707], the pre-input state resulting from a swipe beginning in [708], namely the letters q, w, e, r, and t each associated to the region containing the swipe-switch which will input the letter when activated. That is, an actual swipe matching the swipe-switch in [709]-[713] will input the letters q-t respectively. It should be stressed that the input in this embodiment depends on swipe-switches, that is, a combination of key data (a key-down and/or a key-up such that the actual path can be matched to a finite length of ideal path) and swipe data (passing through a particular region containing the ideal path of a particular swipe-switch), not on key data alone or swipe data alone. This is to be kept in mind as we explore input based on swipe data only below.

Turning now to FIGS. 8A-G, we flesh out the presentation of the embodiment described first in reference to FIGS. 7A-B. FIG. 8A reproduces the layout of letters described in relationship to FIGS. 7A-B. This is the base state of the keyboard. Each of the other panels FIGS. 8B-G, shows the pre-input state caused by starting a swipe at or near a group and proceeding towards the interior, for groups qwert to asdfg going clockwise. For each pre-input state, arrows represent the various swipe-switches available in that state, and at the point of the arrow, the letter which will be input if the corresponding swipe-switch matches the actual swipe performed by the user. Relationships between the order of the swipe switches and the order of letters in a group could be different from the illustrative relationship shown in this figure and yet remain within the scope of this embodiment. The relationship as shown here admits a simple description: for the leftmost symbol in a group, swipe to the left, for the rightmost, swipe to the right, for the center swipe across, and for those symbols in between, swipe in between. Similar patterns can be developed for any other grouped layout, with any number of symbols in a group, limited only by how many different ranges of angle can be practically distinguished given the relative sizes of input and pointing devices, and the skill of the operator. Other things being equal, the fewer the number of groups, and the fewer the number of symbols in each group, the smaller the device that can be operated in this manner.

Crosspair Swipe Segments (Crosspairs)

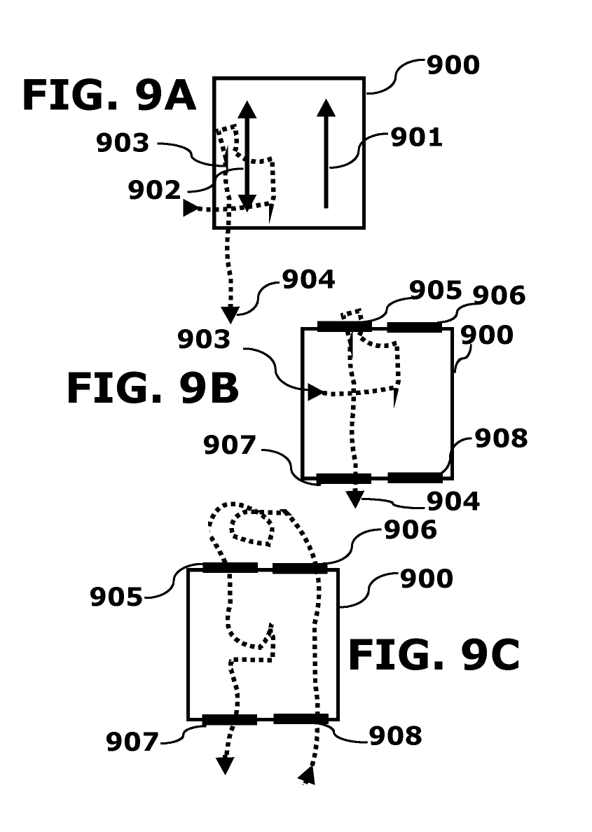

FIGS. 9A-C provide an introduction to crosspair swipe segments, which we will reference to often as crosspairs when no confusion is anticipated. FIG. 9A shows a shape [900] continuing the ideal paths of two swipe-switches [901] and [902] being uni-directional and bi-directional respectively. An actual swipe path is indicated by a dotted line starting at [903] and continuing to [904]. What was the user who made this swipe intending? To swipe up on [901] and then down on [902]? Up on [901] and then up on [902] and then down on [902]? Or simply down on [902]? If there are underlying statistics regarding the likelihood of various sequences of swipe-switch activations in practice, it might be possible to mitigate the ambiguity using disambiguation software. If the swipe-switch matcher is built so that only one swipe-switch can be matched by any gesture which begins with a key down event, followed by a swipe, followed by a key up event, then the ambiguity vanishes: this will be interpreted as a swipe down on [902] since that hypothesis supplies the best match of the actual swipe to the ideal path of a swipe-switch. The problem illustrative here is quite general: swipe-switches are not well adapted to being activated one after the other from a continuous swipe. This can be traced to that fact that in general key data, not just swipe data enter into the actual-swipe to ideal-path matching problem. In FIG. 9B, we identify 4 segments of the boundary of the shape, equivalently, 4 ranges of parameter values in the parameterization of the shape, [905]-[908] indicated schematically by thickenings of the boundary of the shape. A crossing detector can detect when a swipe path traverse though one of these segments, and can tell whether the crossing was from the outside to the inside, or vice versa. The crossing detector is in particular looking for an outside to inside cross, followed by an inside to outside cross, with no intervening crosses. This is a crosspair. In typical implementations, a cross from the outside to the inside followed by an inside to outside cross though the same segment is a null operation, a no-op, an undo. The useful crosspairs are those in which the outside-to-inside cross is through one segment, and the paired inside-to-outside cross is through another segment. We then have the relationship between crosspairs (in, out) in FIG. 9B and swipe-switches in FIG. 9A as follows: ([905],[907])=down on [903], ([907], [905])=up on [903], ([906],[908])=down on [901]. The actual path of FIG. 9A, crosses out via [905], in via [905], out via [907], as the crossing detector would detect. It recognizes the only crosspair as a swipe down, the same as the swipe-switch detector would if it were limited to the choice of only one swipe-switch. The potential advantage of crosspairs over swipe-switches in the case of multiple activations from a single swipe is illustrated in FIG. 9C. Here a single swipe is recognized by the crossing detector as the sequence: in [908], out [906], in [905], out [907], that is, there are two valid crosspairs ([908],[906]) and ([905],[907]), potentially resulting in two actions in sequence when the crossing detector reports its results to the next level of processing. The application to text input is now manifest: an experienced user might be able to input several letters, even whole words, using a single swipe. Similarly, in some other graph, the user might be able to navigate through several nodes of the graph, several levels of decision tree in the case of tree-like graphs, using but a single continuous swipe.

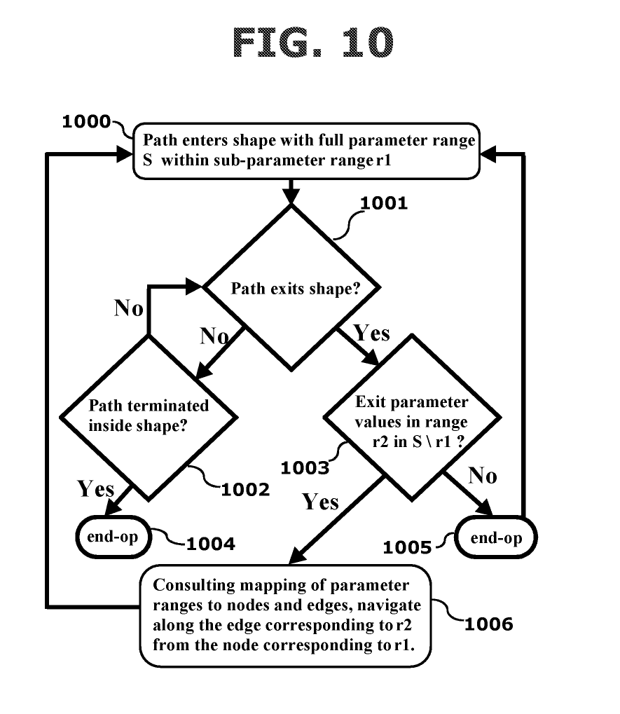

Turning now to FIG. 10, we describe the situation more formally, in reference to a flow chart. According to the flow chart at [1000], a path enters the shape in some range of parameters r1 contained in the full parameter range S, around the entire shape. This is an “in” cross, via the range r1. Then the device continually checks [1001] if the path has exited the interior of the shape. If it doesn't exit, it might be because it terminated inside the shape (a key-up event in the language of touch screens) [1002]. In that case, we're done, and nothing more has been accomplished, the end-op (“end of operations”) steps, if any, are taken [1004]. Otherwise, the path exited the shape, and we ask, at step [1003] where the exit was via a parameter range r2 distinct from r1, with the understanding that the range r2 has is related to a navigable edge (an edge leading away from the current node). If it isn't, e.g. if the exit is back out through r1, then we failed to navigate further in the graph and execute the appropriate end-op operations, if any [1005]. Finally, we check the mapping of parameter ranges to the graph [1006], that is, its nodes and edges, and proceed from the node corresponding to r1 along the edge corresponding to r2. As we will see more completely below, the edge associated to r2 may be associated with a symbol or a sequence of symbols, and in that case the symbol or symbol sequence might be output as the edge is traversed. This would be the case for a text-input system, for instance. The end-op operations will depend on the purposes of navigating the graph in a particular implementation of this apparatus. Consider, for example this illustrative set of increasingly complicated end operations:

1) stop processing the path,

2) stop processing the path and output the accumulated symbol string buffers,

3) stop processing the path, output accumulated buffers, and return to the base node of the graph, and

4) stop processing the path, output accumulated buffers, apply disambiguation algorithms to modify the output, and return to the base node of the graph.

Any of these operations and more might be an implementation of the “end-op” nodes [1004]-[1005] of FIG. 10.

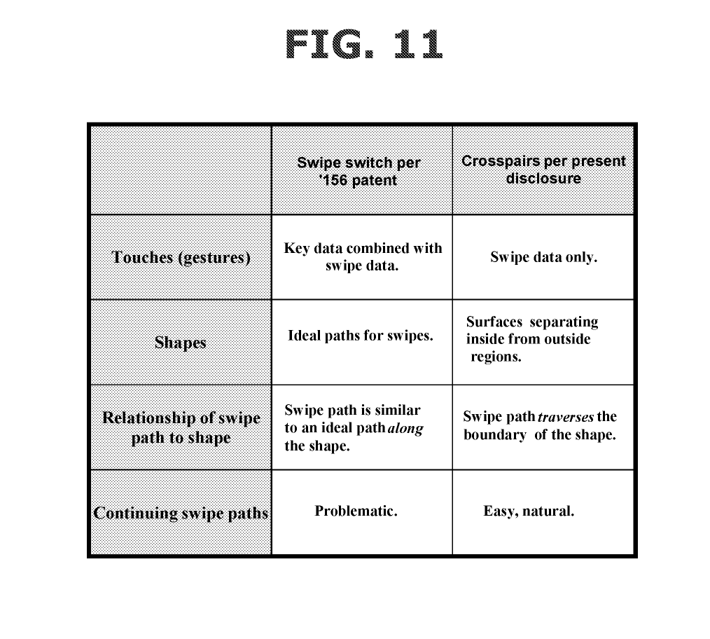

To summarize what we have learned so far about the comparison swipe-switches and crosspair, we turn to the table of FIG. 11. Both swipe-switches and crosspairs are the result of mechanisms for processing actual swipes by humans and associating them with actions by computers, that is, human-computer interfaces. In much of this disclosure we discuss these mechanisms in terms of computers which use touch screens as sensors, and employ the associated language of touches including key-up and key-down events, and swipes. More generally, the interface needs some path generator operable by a human to make paths. These paths will typically have beginnings and endings, corresponding to key-up and key-down events. E.g. in a 3-D gaming system, a user might make a fist to start a path, move the fist to extend the path, and open the hand to end the path. swipe-switches use both the key data and the swipe data for processing, crosspairs depend on the swipe data. Swipe-switches and crosspairs involve “shapes” but in a rather different way. The relevant shape for a swipe-switch is its ideal path, while the relevant shape for a crosspair is the surface it traverses (perpendicularly) at some associated parameter value in the parameterization of the surface, going for outside to inside the shape, or vice versa. As we have noted earlier, activating swipe-switches in sequence, without intervening key events is problematic, while such sequences are executed naturally in systems based on the detection of crosspairs.

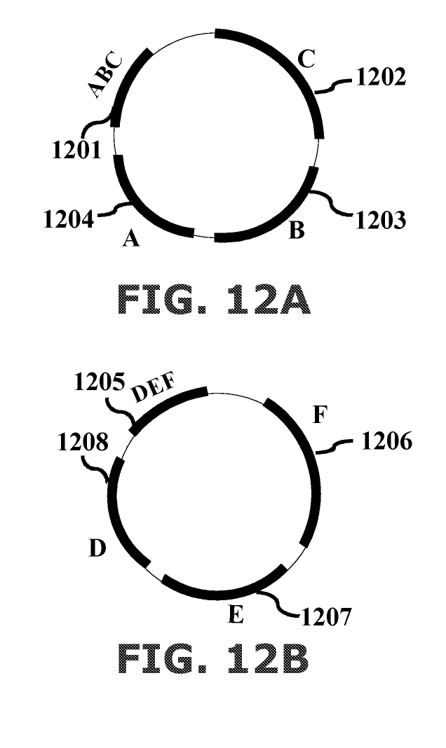

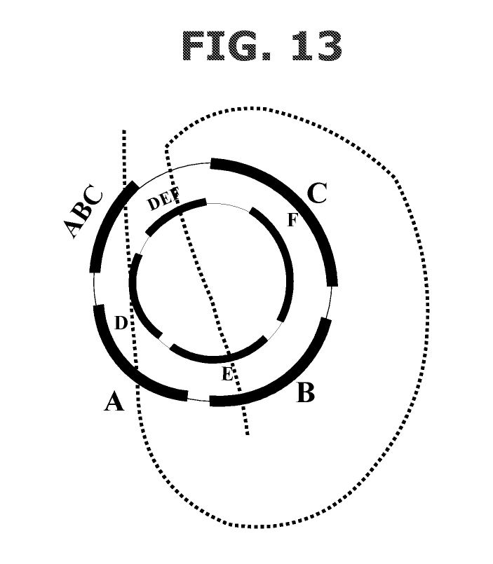

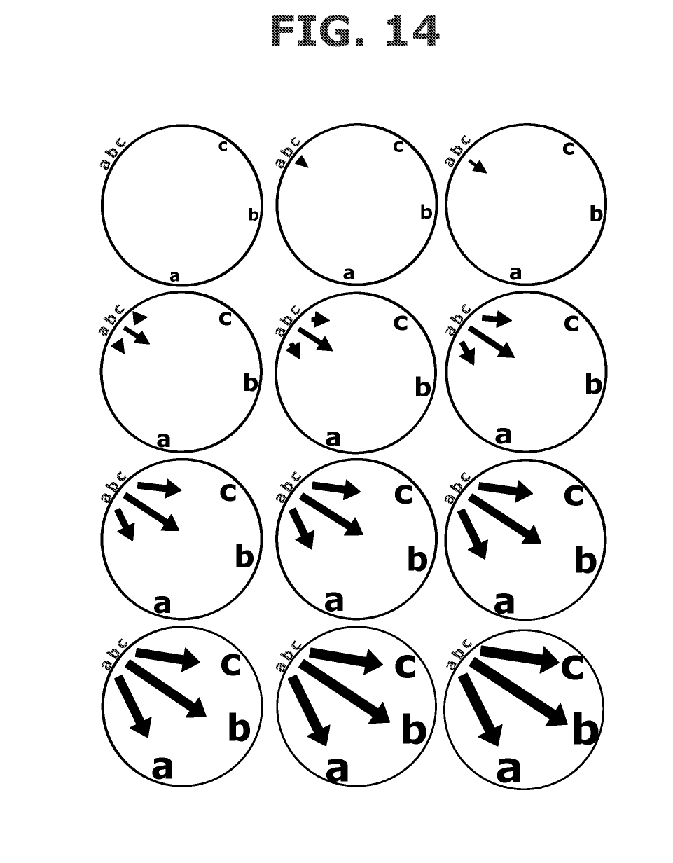

We are now in a position to reformulate the embodiments previously discussed in terms of swipe-switches now in terms of crosspairs, their creation, detection, and processing. It will not be necessary to go over all of these embodiments in detail. It suffices to show one example of how a situation previously treated with swipe-switches can now be treated with crosspairs. For this we turn to FIGS. 12A-B. In FIG. 12A, we see a parameter range [1201] representing the node of a graph labeled “ABC”. If a user swipes from outside the circle to enter the circle in this parameter range, navigation to the ABC node occurs. Then, if the user continues the swipe, without a key-up event, exiting the circle via the parameter range [1204] then navigation will continue along the edge labeled “A” from the node “ABC”, if the exit is rather through parameter range [1203] then the “B” edge will be traversed, and if the exit is via [1202] then the “C” edge will be traversed. The graph for a simple text entry system such as we have described thus far is likewise simple. It has a base node, labeled with all the letters A-Z, with edges to each of the piecewise alphabetic groups into which the letters have been divided, and then edges leading from those nodes terminal nodes, where the terminal nodes are equivalent to the base node. So here, when the user enters the circle via [1201], the edge from the base node to the node “ABC” is traversed,

then, as just described, if the exit from the circle is via [1204] then the edge labelled “A” is traversed, and the letter A is output. Since the next node is a terminal node, and all terminal nodes are equivalent to the base node, we are back at the top of the tree ready to input another letter. We might then continue to swipe around the outside of the circle, re-entering at some parameter value in the region [1205] (FIG. 12B). That would navigate us to the DEF node in the graph. If we continue swiping, without a key up event, and re-exit the circle via some point with a parameter value in the range [1207] then we would follow the edge labeled E and the letter E would be output. In FIG. 13, we provide a diagram of the journey we have just described. This diagram is constructed by schematically representing both the states represented in FIG. 12A and FIG. 12B simultaneously, one state of the shape presented inside the other for readability. Following the actual path (the dotted line) traced by the user, beginning in the upper left, we see the pair of letters AE input, in a single un-interrupted swipe.

Learning Through Animation

Through many embodiments above, we have shown that simple rules can be given for how to use swipe-switches and crosspairs for text input and more generally, graph navigation. However simple the rules, they still must be learned by the novice user. The user needs to learn several concepts, including what constitutes a swipe-switch or crosspair, which gestures active a swipe-switch or create a crosspair, and how those operations affect the output. FIG. 14 presents a first illustrative device to teach users basic operations using animation. FIG. 14 presents successive frames, reading left to right, top to bottom of a short animation. This animation could run spontaneously whenever the device left unused or could be activated when the user taps at or near a group of symbols, here the group abc. It could continue to run in a loop as long as the user presses and holds in that region. In the sequence of frames, letters from the group proceed from their start region to their respect end regions, followed by arrows which grow towards their targets (alternately fixed-sized arrows move toward their targets). Thus the user should learn which pair of input and output regions enters which symbol. If they swipe through another group or tap another group, a similar animation would occur, pertaining to that group. If, while continuing to hold down, the user moves from one group to another, the animation could change from the animation of the first group to the animation of the second group. In a more advanced version, the arrows could sweep over a range pertaining to the full extent of the enter and exit parameter ranges.

Auxiliary Display

FIG. 15 augments the basic shape used for graph navigation with an auxiliary display [1505]. The auxiliary display provides a view into the current state of the graph-navigation system. It can be useful not only for learners, but for expert operators. FIG. 15 illustrates a device to be used for navigating a text-input graph using crosspairs. As in other previously discussed embodiments, letters (and other symbols) are area shows a shape in piecewise alphabetic order. To the group of letters in each piece, an entrance parameter range is defined relating to a node in the graph, and various other exit ranges in the complement of the entrance range are also defined, each relating to a navigable edge emanating from the entrance node. Show here is a shape [1503], the entrance range [1509] relating to the group abc [1504], and exit ranges [1510]-[1503] relating to the letters a, b, and c respectively. To see how this works, consider an actually swipe path [1507] which passes from outside the shape [1502] to the inside of the shape [1501]. When the FIG. 15 snapshot of the state of the device is taken, the swipe has progressed to the point [1508], but there has not yet been a key up event ending this swipe [1507]. A dotted line [1513] is drawn to show a connection between the entrance range and the exit range which the device estimates that the user is intending, at the moment of the snapshot, to make a crosspair from. In other words, given where the swipe entered the shape, and where it now it appears to be heading, it looks like the user is intending to input the letter “a” by forming a crosspair between regions [1504] and [1510]. Note carefully that [1513] is not the ideal path of a swipe-switch in this illustrative embodiment, though in an embodiment based on swipe-switches it could be. Rather it is an efficient, in the sense of least effort, path from apparently intended entrance range and exit range. Showing [1513] to the user helps them understand that a quick way to input “a” would be to follow that direct path, rather than wandering around in the interior of the shape which they are presently doing. If the path does in fact exit the shape via range [1510] then the letter “a” will be appended to the output text buffer and shown in [1506], and the content current-state display [1505] would be appropriately modified, either being cleared entirely, showing temporarily just the letter “a”, flashing to show completion of a crosspair, or other more gradual modifications to be discussed below.

We now turn to FIGS. 16A-D which provide further details of the operation of the embodiment of FIG. 15 showing how [1507] can be used to dynamically guide a user to efficiently create a crosspair. FIGS. 16A-D is a sequence of snapshots meant to show that as the actual swipe [1507] extends, a representation of an efficient path [1513] for creating the crosspair the user is apparently intending to create also extends. Seeing this extension of [1513] may help the user quickly complete their current crosspair, and learn how to make such crosspairs more efficiently in the future.

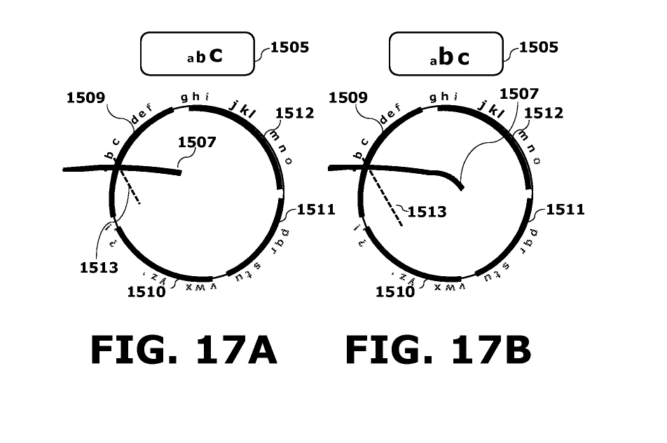

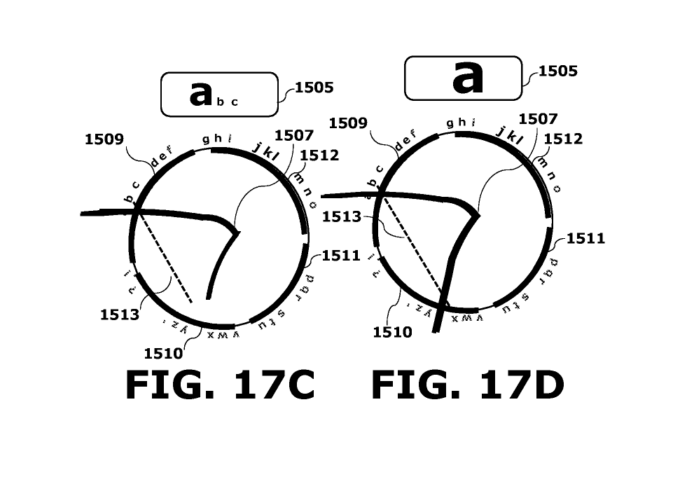

The auxiliary display [1505] can also be used to provide dynamic guidance to the user. This is illustrated in FIGS. 17A-D, to which we now turn. FIGS. 17A-D show the progress of an actual swipe [1507] being reflected in changes in characteristics of the information in the auxiliary display [1505]. Here, illustratively, the font characteristics are changed as the actual swipe [1507], progresses. FIGS. 17A-D chose to change font size, though other characteristics, including other font characteristics could be modified to similar effect. That is, as the swipe [1507] progresses over the panels FIGS. 17A-D, the size of the letters a, b, and c change in the auxiliary display, the size of the font of a letter corresponding to the estimated likelihood that that letter is intended to be input by the user. Thus, in FIG. 17A, it appears that “c” is the intended letter, though “b” is also a possibility, so “c” appears in [1505] in larger font that “b” which in turn appears in larger font than “a”. By the time the snapshot of FIG. 17B is taken, “b” appears most likely, and is shown in the largest font. In FIG. 17C, it appears overwhelming likely that “a” is the intended letter, and so “a” appears in very large font in the display [1505], and the font for “b” and “c” correspondingly reduced in size. Finally, at FIG. 17D, a crosspair has been created as the path [1507] has passed through the parameter range [1510] corresponding to “a”, and so “a” appears alone in the auxiliary display [1505]. There is no possibility that “b” or “c” were intended, so their font size is set to 0. It should be evident by now to the person skilled in the art that other characteristics of the display could have been used as progress indicators, that the feedback mechanism could appeal to other senses, such as audition, rather than the visual sense as described here, and that the same approach will work for systems based on swipe-switches rather than crosspairs, or mixed swipe-switch/crosspair systems. In the case of swipe-switches, the relative likelihood of the various outcomes from an actual swipe would be computed using information from the ideal path to actual path matching system, perhaps combined with a prediction module which predicts where the actual swipe is going based on its velocity, etc.

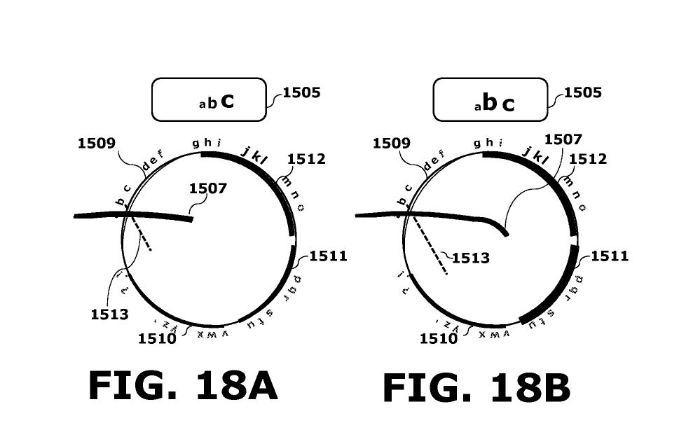

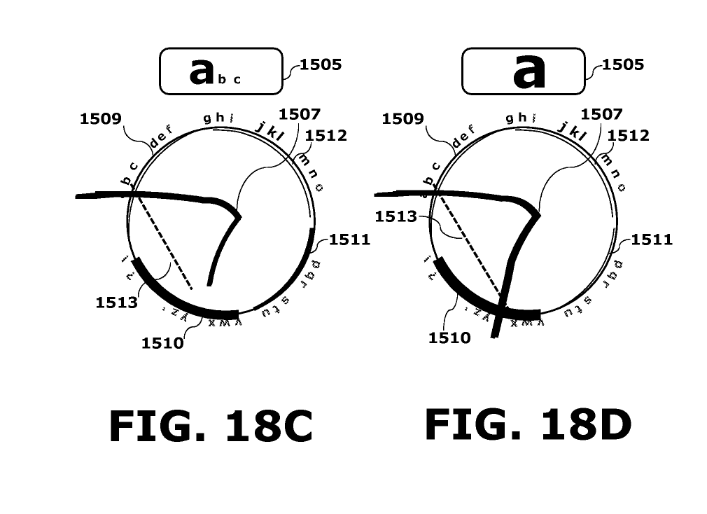

In the case of crosspairs, it is preferable to have not only an indication to the user of where a swipe is likely going, but confirmation as to when a shape has been traversed from inside to outside completing a crosspair. An illustrative system for doing so is shown in FIGS. 18A-D, to which we now turn. We already saw in FIGS. 17A-D that creation of a crosspair can be indicated in the display [1505] by the reduction of a representation of a variety of possible outcomes to the representation of a single, actually occurred outcome, and progress toward that outcome indicated by font size. That impact is augmented in FIGS. 18A-D by varying the highlighting of the various exit parameter ranges in accordance with the likelihood that an exit will occur there. In FIGS. 18A-D, the degree of highlighting of a given parameter range is indicated by the thickness of the shape boundary corresponding to that parameter range. For instance, in FIG. 18A, “a” appears to be the least likely outcome and “c” the most likely. Thus, the shape boundary in the parameter range for an exit producing “a” is shown with a thin line, and the shape boundary in the parameter range for an exit producing “c” is shown with a thick boundary. As we further progress through FIGS. 18B-D, we see the parameter ranges [1510]-[1512] being progressively more or less highlighted, as their likelihood as the exit range changes with the progress of the swipe in the interior of the shape. Finally, at FIG. 18D, exit has actually occurred and the highlight of the corresponding segment [1510] becomes (briefly) very intense indeed. This signals to the user that the crosspair has been formed, a signal confirming the signal found in the auxiliary display [1505].

While the principles of these feedback mechanisms were illustrated using visual stimuli, It should be evident that these embodiments could be suitably modified to provide guidance to the user via auditory, olfactory or tactile means. For instance, the device might generate different tones or vibrate differently depending on one or more of: which group is currently selected, whether the current point is inside or outside the boundary, how far from the selected group the current point is, which portion of the boundary is being exited through or aimed at.

Systems with Graph Navigation Both with Swipe-Switches and Crosspairs

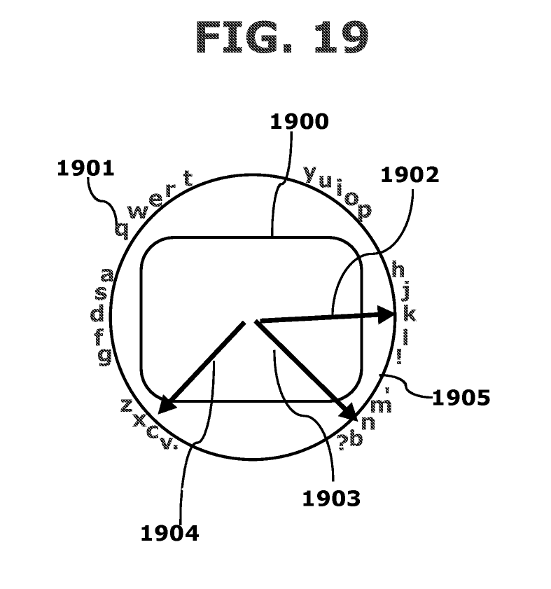

We have mentioned several times that graph navigation systems could be built based both on swipe-switch matching and crosspair detection. To the extent that gestures activating swipe-switches are ignored by a crosspair detector and vice versa, the two types of mechanisms can peacefully co-exist. We would not like to briefly discuss one such system for illustration, in reference to FIG. 19, to which we now turn. The embodiment of FIG. 19 is similar to the embodiment described in relationship to FIGS. 6A-B and FIGS. 8A-G, except a) the piecewise letter groups are regularized differently (though, in general, no regularization is required, it is simply preferable), b) punctuation symbols are entered either via a separate punctuation mode or, for the most common punctuation systems in the alphabetic mode, using swipe-switches, and c) letters are input via crosspair detection, rather than using swipe switches. These modifications are for illustration purposes only. The purpose here is to more clearly show the distinction between input by swipe-switches and input by crosspair detection by having each associated to a different class of symbols. It is also clear that the illustrative embodiment of FIGS. 6A-B and 8A-G could also have a punctuation mode, and digit mode, etc. FIG. 19 shows a shape [1905], a display [1900] for displaying text inside the shape, an arrangement of letters a-z following a piecewise typewriter ordering [1901], each of which letters are input via the creation of crosspairs (the details of which mechanism have been described elsewhere in relationship to other embodiments), and 3 swipe-switches, the ideal paths of which are represented by the arrows [1902]-[1904] for the input of punctuation symbols, !, and ?, and . respectively. Note that swipe-switch [1903] is ambiguously associated to two punctuation symbols, apostrophe and question mark. As these two symbols generally have rather different statistics of occurrence in written languages, which of the symbols is meant could generally be reasonably determined using disambiguation (predictive text) software. The swipe-switches have a start region in the display [1900]. A swipe which starts with a key-down event in [1900] and proceeds outward will not be confused with a crosspair, even if it crosses the shape from the inside and terminates outside the shape, since there would be no corresponding cross from outside to inside on the same swipe, so no crosspair formation. Conversely, a swipe intended to form a crosspair would not activate a swipe-switch, since the ideal path to swipe-switch matcher would be configured to required a key-down event inside the display to form a match. Thus crosspairs can be used to input letters, and swipe-switches to input punctuation, with no interference. We note that we could have set up the system to input some letters via swipe-switches, others using crosspair detection. Or some punctuation with crosspairs and other punctuation with swipe-switches. The association of symbol class to gesture classification task is for illustrative purposes only in this embodiment.

Image Classification

Though we have focused up to now on graph navigation for text input, the same techniques can be used for a wide variety of graphs, and a wide variety of associated tasks. For a relatively simple illustrative example, we consider an image classification problem. The user is presented with a set of images which they are to classify by sorting them into a hierarchy of pre-determined classes, operating a user interface according to the present teachings to do the sorting. The configuration of the user interface depends on the structure of classes: each top-class may have one or more subclasses, each sub-class several sub-sub-classes and so on. To aid users in performing their classification task, the user interface may be reconfigured from time to time as the task proceeds, perhaps after every action performed by the user.

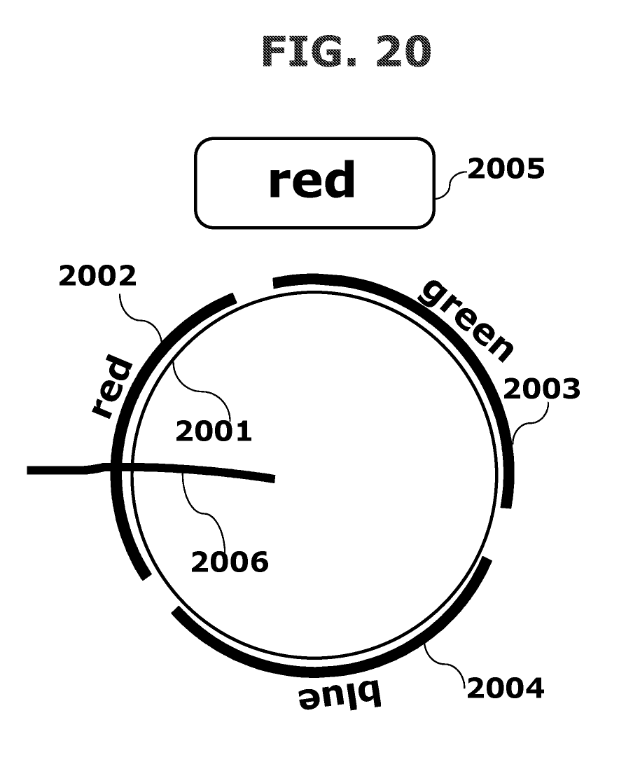

To make this illustration still more concrete, we turn to FIG. 20 for a possible implementation. Here, an image the user is to classify is shown inside of a shape. For illustration, the shape here is a circle [2001], though any largely closed shape will do. The user swipes across the circle [2001] through one the three regions [2002]-[2004] to classify the image in to a corresponding class red, green or blue respectively. Preferably, the name of the apparently intended class appears in the display [2005] as the user swipes from the outside to the inside of the circle. The swipe path thus far in the snapshot is shown as [2006]. The user has swiped across region [2002] of the shape [2001] which corresponds to the class red, so the word “red” is displayed in the display [2005]. If that is not the desired class, the user can swipe back to the outside of the circle though region [2002] and then re-enter to the circle in another region to choose a different class. Conversely, if red were indeed the desired class, they can complete the swipe by exiting the circle via any part of the circle other than [2002]. To choose blue or green, the user would swipe from the outside the circle through the regions [2003] or [2004] respectively, and then exit the circle again through the complement of their chosen start region.

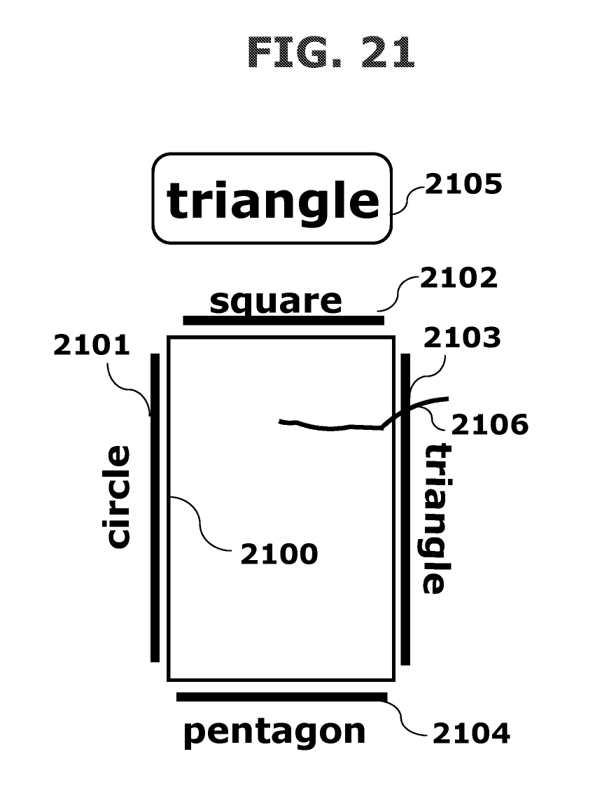

In this illustrative example, class red has 4 sub-classes circle, square, triangle, and pentagon. Having selected the red class, the user interface changes accordingly, so that the user can select one of these sub-classes with their next swipe. This is shown in FIG. 21 to which we now turn. Now the circle [2001] has conformally morphed into a square [2100] which is divided into 4 start regions [2101]-[2104] for circle, square, triangle, and pentagon respectively. Thus, the interface changes responsively, depending on the task immediately at hand, and based on context. In this case, the context comprises the structure of the classification scheme, and the node in the structure selected by the previous swipe. To chose one of the four shapes, the user would swipe from the outside the square [2100] through the corresponding start region in the set [2101]-[2104] and exit the square [2001] via the complement of the chosen start region. Thus, with a single swipe, first through the circle [2001] and then through the square [2100], the user could classify a shape as e.g. a green pentagon. Continuing with more levels for more characteristics of a shape, a user could identify e.g. a green pentagon with a dotted-line border and containing the image of a flower, and so on.

It should be clear that image classification is just one of many tasks which can be handled by the input technology discussed above. Consider, for instance, choosing an item from a restaurant menu. At the first level, there might be choices such as pasta, pizza, or paella. If pizza is chosen, then the next levels might be used to chose the size, type of crust, and/or type of toppings of the pizza. As another example, consider games where the finite number of plays available to the player depend on the outcome of previous plays. In short, any task which involves a finite-state machine can be supported by these embodiments. At each decision point (node), the user interface can be modified so as to make it easier for the user to specify their decision (edge to follow), and to verify that the decision has been properly input.

As another example, consider that the technology could be used as an app, and for setting apps in the app thus launched, potentially all with a single swipe gesture.

L-Shaped Swipes: Annular Swipe Switches, Combined with Crosspair Swipe Segments

L-shaped swipes are a crosspair segment, modified by an annular swipe-switch which continuously and immediately follows it. Additional symbols or functions could be entered by extending L-shaped swipes still further, the practical number of variants limited only by the gesture resolution of the device and the skill and training of the operator. For instance, L-shaped swipes could enter different symbols depending on the length over which the swipe-switch foot of the L is drawn. A short foot could indicate one action, and a longer foot another. L-shaped swipes could be extended to T-shaped swipes by requiring that the user swipe first in one direction along the annulus and then the other. T-shaped swipes could also be classified depending on the distance travelled clockwise and/or counter-clockwise along the annulus. This is discussed more fully below.

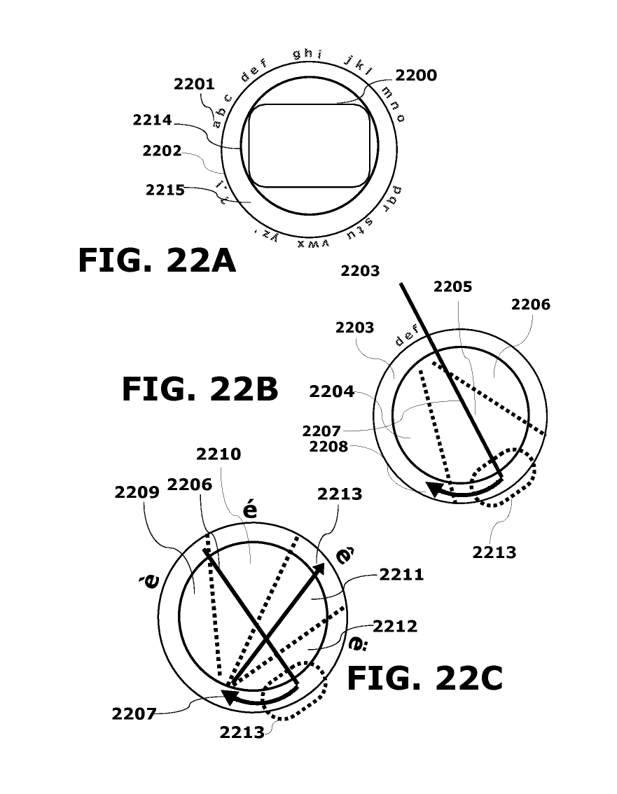

The L- (or T-)shaped swipes could be used for a variety of purposes, some of which will be explored in the following embodiments. In general, they increase the complexity of the graphs which can be handled. FIG. 22A, to which we now turn, illustrates the use of L-shaped swipes for the input of accented letters. The device of FIG. 22A incorporates a display [2200], a keyboard [2201] operated via detection of crosspairs relative to a shape [2214]. FIGS. 22A-C feature an annulus [2215] created by surrounding the shape [2214] with another shape [2202]. If a crosspair swipe travels though its starting region of shape [2214], exiting through the shape [2214] and then continuing within the annulus [2215] an additional set of symbols become available for input. This functionality is illustrated in more detail in FIG. 22B. This is the same device as that of FIG. 22A, though the drawing suppresses certain lead lines, part numbers and aspects for clarity. FIG. 22B shows a swipe path comprising the part [2207] passing through a parameter range of [2214] corresponding to the group def, and further exit parameter ranges delimited by the intersection of the interior space regions [2204]-[2206] with the shape [2214] for the letters d, e, f respectively. Thus the first part of the swipe [2207] exits through the middle range [2205] and thus corresponds to the letter e. The swipe also comprises an annular part [2208], which travels within the annulus [2215]. The annular part is here shown going clockwise, but it could also go counter-clockwise, or clockwise and counter-clockwise all with different effects, e.g. resulting in different subsequent options. The annular part of the swipe activates a swipe-switch with start region [2213] and an ideal path inside the annulus [2215]. As mentioned, the crosspair part of the swipe [2207] corresponds to the letter e. In certain languages, say French, the letter e can carry a number of accents. In FIG. 22C, some accented letters e's are shown arrayed about the boundary. Each of these may be associated with new exit regions delimited by the intersection of the space regions [2209]-[2212] with the shape [2214] such that if the swipe continues further to re-enter the shape [2214] and exit through one of the new exit regions, then one of the corresponding accented letters è, é, ê and \tilde{e} respectively will be input, rather than the base letter e which would be input had the annular swipe-switch not been activated. For instance, if the initial part of the swipe [2207] had simply continued beyond the swipe-switch start region [2213], exiting shape [2202] as well as shape [2214] then the simple base letter e would have been input without an accent. If still more accented letters were needed they could be provided, for instance, by distinguishing clockwise and counter-clockwise annular swipes, using T-shaped swipes, slicing the 2nd-order parameter range more finely or using these methods in combination.

It should also be noted that annular swipes could be used instead of or in additional to crosspair swipes to input base letters from a group; rather than being used to further specify the characteristics of a letter entered by a crosspair swipe. For instance, in a group of three symbols arrayed near the boundary, a counter-clockwise annular swipe following a crosspair could be used to enter the first of the three, a clockwise annular swipe used to enter the last of the three, and a swipe-switch with an ideal path towards the center could input the middle symbol.

Devanagari

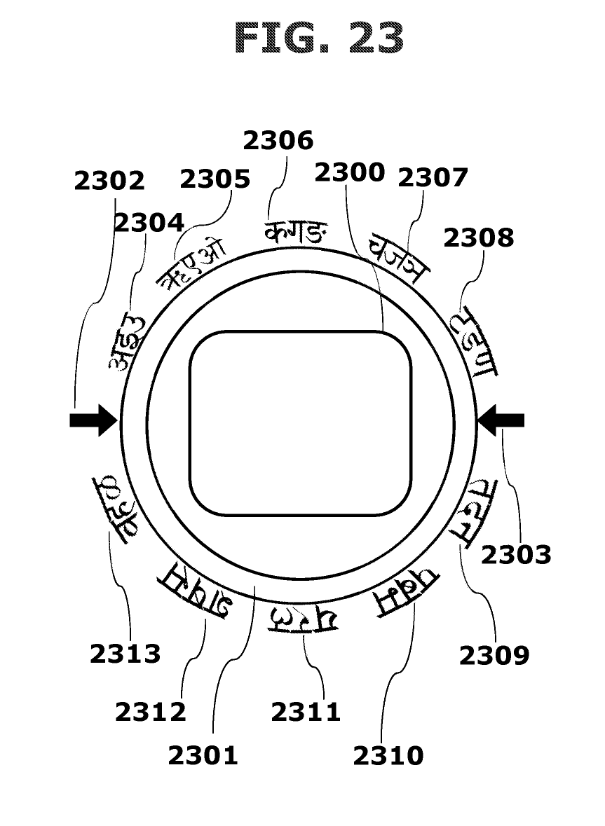

Though the utility of combining crosspair swipes with annular swipes into L- and/or T-shaped swipes has already been well documented with the illustrative embodiment of FIGS. 22A-C, we will provide a further illustration of their potential uses in FIG. 23 by considering a possible treatment of the Devanagari script used to write Hindi among other languages. We will use Hindi as a reference for illustration. We will delve into considerable detail in our illustrative treatment of Devanagari. It should be understood that these details are not meant to limit this embodiment or the utility of L- and T-shaped swipes more generally, rather they are meant to provide a rather complete working example of the treatment of a complex script within the scope of the appended claims, with the intention of teaching that the same technology could be applied to any complex script, and more generally quite complicated graphs, while still remaining within the scope of the appended claims. Devanagari, like Japanese Hiragana and other scripts, has a generally tabular structure, with various irregularities. We already know how to treat symbol tables: typewriter keyboards present symbol tables as discussed relative to previous embodiments. The complications arise from the fact Devanagari is generally represented as several sub-tables, including a vowel table, and several consonant tables. Devanagari also uses vowel signs, various marks, and consonant conjuncts. There are many ways the new technology herein disclosed could be applied to allowing all or part of the set of symbols in this structure to be input.

The approach taken in FIG. 23, to which we now turn, is to reduce the number of symbols in each group of symbols in a row of a table in exchange for more extensive use of annular swipes. We seek in this embodiment to limit the maximum number of symbols in each group of symbols on the boundary to 3, despite the fact that the table rows for Devanagari may contain more than 3 symbols. In particular, most consonant rows contain 5 symbols. To achieve the limitation of 3 symbols, we will use certain linguistic structures within the rows to assign parts of the rows to crosspair swipes or to crosspair swipes combined with annular swipes. For instance, vowels may have short and long variants and consonants may have both aspirated and un-aspirated forms. These distinctions allow us to split the rows into smaller pieces. In summary, we will use 8 keyboard groups for consonants and 2 for vowels. We will also allow for space and backspace to be entered via swipes. We will use crosspair swipes alone or combined with annular swipes to input the full set of vowels and consonants required for commonly used Hindi. We will also use this method to perform other functions, such as designate a consonant to be part of a consonant conjunct.

To begin this discussion, we turn to FIG. 23. The device of FIG. 23 comprises a display [2300] and a keyboard comprising 12 groups of symbols [2302]-[2313] arranged around a shape. A crosspair swipe traveling through or near one of the groups passes though the parameter range associated to that group. The shape is surrounded by an annulus [2301] within which swipe segments may be made which do not register as crosspair swipes but rather activate annular swipe-switches as described above in relationship to FIGS. 22A-C. Two of the keyboard groups [2302] and [2303] are singleton groups, inputting the symbols space and backspace respectively. The other groups [2304]-[2313] are used to input various symbols from the Devanagari abuguda, which are presented in piecewise alphabetic order (tabular order).

Vowels

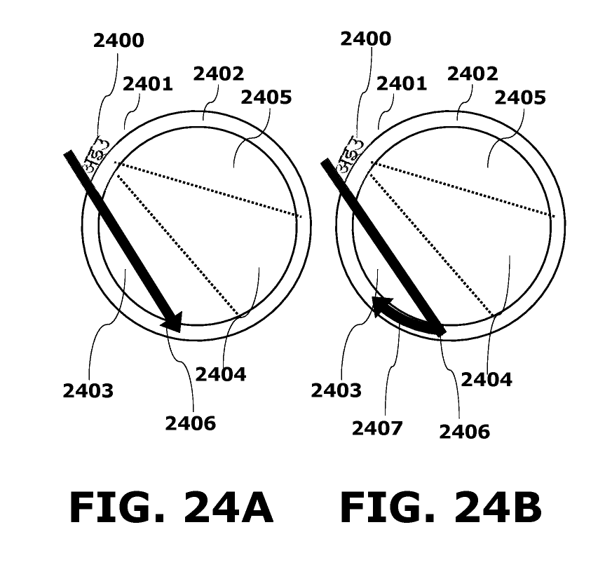

Groups [2304]-[2305] are used to input vowels via crosspair swipes. There are three types of vowels short, long, and diphthong. There are 11 vowels commonly used in Hindi. All but one of these occur in pairs, either (short, long) or (long, diphthong). One vowel is only short. Thus there are 6 either paired or singleton units, which we group into two groups of 3. In the case of pairs, one of the pair is entered via a crosspair swipe, the other is entered by a crosspair swipe followed by an annular swipe. The singleton only requires a crosspair swipe. We turn briefly to FIGS. 24A-B to discuss this situation in more detail, whereupon we will return to FIG. 23 to discuss further aspects of that drawing. FIGS. 24A-B are versions of FIG. 23 in which details not needed for the present discussion are suppressed, and additional features are newly pointed out. The devices of both FIGS. 24A and 24B comprise a part of the keyboard, the group [2400] containing vowels ([2400] corresponds to [2304] in FIG. 23). The dotted shape [2401] shows the start region for a crosspair swipe inputting any of the symbols of [2400], and [2402] indicates an annular region which crosspair swipes must traverse to input a symbol. The three regions [2403]-[2405] are the regions a crosspair swipe must traverse (wholly or in part) to input the symbols [symbol] (U+0905),

[symbol] (U+0907), and [symbol] (U+0909) respectively. The arrow [2406] in FIG. 24A indicates an example swipe inputting [symbol] (U+0905). Implicitly, the group [2400] also contains the long vowels [symbol] (U+0906), [symbol] (U+0908), and [symbol] (U+090A), each corresponding to their short vowel companions [symbol] (U+0905), [symbol] (U+0907), and [symbol] (U+0909) respectively. The long vowels are input by the same crosspair swipe that inputs the short vowel counterpart, provided that the crosspair swipe is continued by an annular piece. The input of the long vowel [symbol] (U+0906) is shown in FIG. 24B, where the crosspair swipe [2406] is continued with an annular swipe [2407] activating the annular swipe-switch.

The input of the remaining 5 vowels, 3 shown explicitly in [2305] of FIG. 23, and two others implicitly input using crosspair/annular swipes proceeds on the same model as described in the paragraph above. In this case, the first symbol, [symbol] (U+090B) has no counterpart in common use in Hindi, and the other two explicitly shown (long) vowels, [symbol] (U+090F) and [symbol] (U+0913) are input with crosspair swipes, while their (diphthong) counterparts, [symbol] (U+0910) and [symbol] (U+0914) are each input using a crosspair swipe continued with an annular swipe. Clearly, other letters less used in Hindi and/or more used in some other language written in Devanagari could be input with a modification of this approach.

It should be noted that in Devanagari vowels may occur in both independent and dependent forms. It is generally possible to determine which of these is meant from context, as independent vowels typically occur at the start of a word or after another vowel. However, an annular “hook” on a vowel crosspair swipe could confirm that that swipe was meant to input a vowel sign. That is, we have used an annular swipe in the clockwise direction to input the second member of a pair of vowels, but we could use a swipe in the counter-clockwise direction to indicate that a vowel is to be treated as a vowel sign. A T-shaped swipe, going first clockwise, then reversing course to go counter-clockwise could designate the second member of a vowel pair as a vowel sign. The use of T-shaped swipes will be further illustrated below in the context of the input of consonants.

Consonants

Turning back to FIG. 23, we begin our discussion of the consonant groups [2306] to [2313]. The first 5 of these [2306]-[2310] are very regular in structure, reflecting the underlying regularity of the script. Each contains 5 consonants: 3 unaspirated two of which have an aspirated counterpart. The 3 unaspirated consonants in each group are shown about the periphery of the device (or relevant area of the device), and are input by crosspair swipes. For those consonants which have an aspirated version, that aspirated version is input by the crosspair swipe for the unaspirated version, followed by an annular swipe, much along the lines described in relationship to FIGS. 24A-B for vowel pairs. In effect, the annular part of the swipe aspirates the consonant.

Let us consider the group [2306]. The group contains the symbols [symbol] and [symbol] , U+0915 through U+0919 respectively. Of these, [symbol] and [symbol] are aspirated. They are input using crosspair swipes combined with (clockwise, say) annular swipes, just as was done in FIG. 24 for vowel pairs. Specifically, when a crosspair swipe inputting [symbol] is continued clockwise along the annulus, it inputs [symbol] instead. And when the crosspair swipe inputting [symbol] is continued clockwise along the annulus it inputs [symbol] instead. The groups [2307]-[2310] behave in exactly the same way, apart from the relevant differences in symbol range for each.

We now turn to the input of symbols in the groups [2311]-[2313] of FIG. 23. Illustratively, we permit ourselves here less than strict adherence to tabular structure and collation order for the sake of maintain regular-sized groups. In particular, there are 4 sonorant consonants, 3 sibilant consonants, and 2 “extra” letters which we would like to permit to be input with this embodiment. We chose to group one of the sonorants with the 2 extra letters, to make 3 groups of 3 symbols namely [2311]-[2313]. The first of the, [2311] contains the first three sonorant consonants [symbol] (U+092F, U+0930 and U+0932 respectively). The second group [2312] contains the sibilant consonants [symbol] and [symbol] (U+0936 through U+0938).

The third group [2313] contains the fourth sonorant [symbol] (U+0935) and the two extra letters [symbol] and [symbol] (U+0939 and U+0933).

Consonant Conjuncts

Consonants may be combined into consonant conjuncts. Both aspirated and unaspirated consonants might be part of a consonant conjunct. We have shown above how unaspirated consonants may be input using crosspair swipes, and their aspirated counterparts input by crosspair swipes with an annular continuation. In both cases, these consonants can be marked as part of a consonant conjunct by further use of annular swipes. We have already noted that aspiration can be marked by an annular swipe in one direction (say clockwise). In a similar way, the intrinsic vowel of a consonant can be “killed” by an annular swipe in the other direction (in this case, counter-clockwise). Killing the intrinsic vowel in a consonant prepares it for membership in a consonant conjunct. Single constants may have their vowel killed by use of a virama sign. In effect forming a consonant conjunct of one consonant. Software can be used to determine from context whether the vowel-killing counter-clockwise part of a swipe was meant to input a virama or to set up the consonant as part of consonant conjunct, and to render the glyphs accordingly. The case of consonants which are both aspirated (requiring a clockwise annular part of the swipe) and part of a consonant conjunct (requiring a counter-clockwise annular part of the swipe) can be handled by T-shaped swipes, comprising first a crosspair swipe, then an annular swipe in one direction, reversing course along the annulus and proceeding in the opposite direction.

Diacritical Marks

In Devanagari, both vowels and consonants may be modified by one or more signs. These include the candrabindu, anusvara, visarga, and nukta signs, [symbol] (U+0901), [symbol] (U+0902), [symbol] (U+0903) and [symbol] (U+093C) respectively. These can be often be entrusted to context-aware software to automatically input when required. However, as we will now show by way of illustrative example, various methods are available permitting the user to explicitly input these marks when desired, using gestures which are consistent with all that has gone before in this disclosure.

Long Annular Swipe

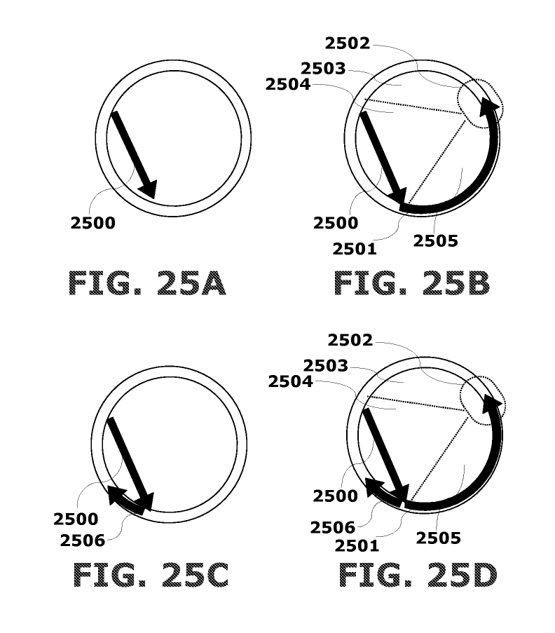

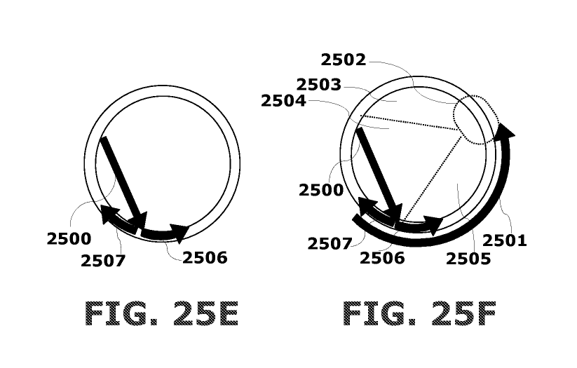

In the context of the foregoing, there are two cases to consider: either the symbol required an annular part of the swipe to input, or it did not. In either case, it is possible to modify the symbol with one of these marks. In FIGS. 25A-F, we will consider solving both of these cases using a method we will call long annular swipe. In the cases of annular swipes considered above, variously for changing the class of a vowel, adding accent marks for Latin script, aspirating a consonant, or marking a consonant as part of a consonant cluster, we have not specified the length of the annular part of a swipe, only at most its direction. For the embodiment of FIGS. 25A-F, we introduce length classes of annular swipes. There could be any number of classes, limited only by the resolution and size of the hardware, and the skill of the operator. Let us consider having two classes: short annular swipes, which are used for some purpose such as those illustrated in embodiments described above, and longer annular swipes used for some other purpose. Optionally, to improve our ability to distinguish short from long annular swipes, we can impose as well the following conditions: 1) a long swipe, if any, follows any short swipes pertaining to the input of the same symbol, and 2) the long swipe proceeds in the opposite direction of the short swipe (if any) which immediately precedes it. To see how this works, we will consider adding a long annular swipe to 1) a simple crosspair swipe (FIGS. 25A-B), 2) a crosspair swipe followed by a short annular swipe (FIGS. 25C-D) and 3) a T-shaped swipe (FIGS. 25E-F). FIG. 25A shows an exemplary crosspair swipe [2500]. FIG. 25B shows [2500] continued with a long annular swipe [2501]. Where ever [2501] ends, there is created a new enter region [2502] for crosspair swipes. There are 3 slices, [2503]-[2505], each corresponding to a diacritic mark. These regions will be assigned the marks candrabindu, visarga, and nukta respectively if the preceding crosspair swipe was for a vowel, and anusvara, visarga, and nukta respectively if the preceding crosspair swipe was for a consonant. To add one of the diacritical marks to the symbol currently being input, the user need simply continue with a crosspair swipe into the desired region.

FIGS. 25C-D are similar to FIGS. 25A-B, except that now we have a crosspair swipe [2500] followed by a short annular swipe [2506] as shown in FIG. 25C. We then add a long annular swipe to follow the short annular swipe. Since the short annular swipe [2506] is going clockwise then, according to the rule announced above, the long annular swipe [2501] should go counter-clockwise. This is as shown in FIG. 25D. As in FIG. 25B, where ever [2501] ends becomes a new start region [2502] for crosspair swipes, with corresponding slice regions [2503]-[2505] opened up.

Now turing to FIGS. 25E-F, we consider adding a long annular swipe [2501] to a T-swipe comprising a crosspair swipe [2500], a short annular swipe [2506] going counter-clockwise, followed by a short annular swipe [2507] going clockwise as shown in FIG. 25E. Since the just previous short annular swipe [2507] is clockwise, the long annular swipe [2501] is made to go counter-clockwise, as shown in FIG. 25F. In FIG. 25F the long annular swipe [2501] is show somewhat displaced from the annulus, though it in fact goes along the annulus, to avoid obscuring the other parts of the swipe. Once again, regions for crosspair swipes to input diacritics [2502]-[2505] are opened up according to the ending position of the long annular swipe [2501].

Note that other methods are available within the scope of the claims and previous illustrative embodiments for handling diacritical marks. For instance, one could use swipe-switches to or from central regions to input these marks, along the lines of the embodiment of FIG. 19. This would be suited to devices which are large enough to have usable central regions. One could also simply add another group to the keyboard containing diacritical marks. Further note that long annular swipes could be used for functions not directly keyboard related, such as scrolling back and forth in a list.

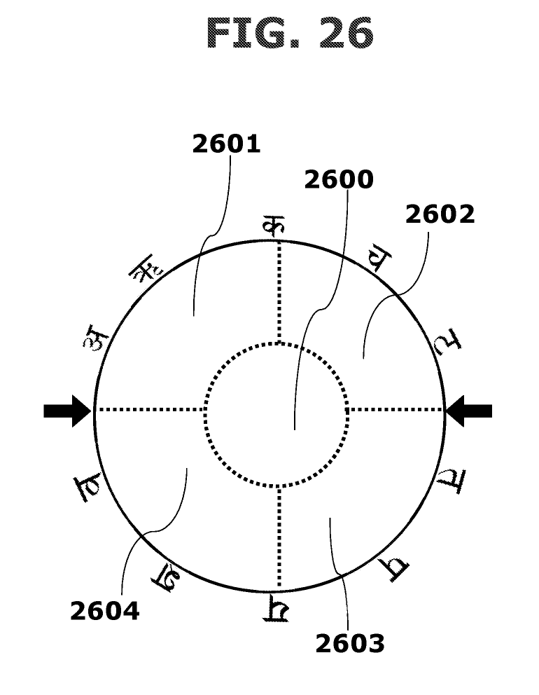

One could also perform various graph navigation functions using simple keys. Since the gestures used to active keys do not interfere with gestures activating swipe-switches or crosspair swipe segments, keys can be used whenever a design calls for them. To see how this might work in the case of Devanagari, we turn briefly to FIG. 26. Here each symbol group is represented by a single representative symbol from the group. A person literate in a language written in Devanagari should immediately recognize which group is being referred to and know all the group members. In FIG. 26, these representative symbols are placed at clock points, making this design particularly suitable for text input on a smart watch. The device of FIG. 26 is further furnished with a set of tap regions [2900]-[2904] taps in which could add functionality to any of the embodiments for Devanagari discussed above in reference to FIGS. 23-25A-F.

In summary, we have shown that even a very complex graph, representing a complex script with many individual symbols, such as Devanagari, can be handled within the scope of the appended claims. The illustrative methods for handling these complex scripts have many alternatives still with the present scope. For instance, some of the complications we have treated with annular swipes, short, long, L and T could also be handled by arranging the various symbol classes in modes and using some other gesture, say taps, to change modes. In any case, we have demonstrated that languages written in these scripts could be written even on very small devices; an extraordinary accomplishment wholly unanticipated in the prior art.

Japanese

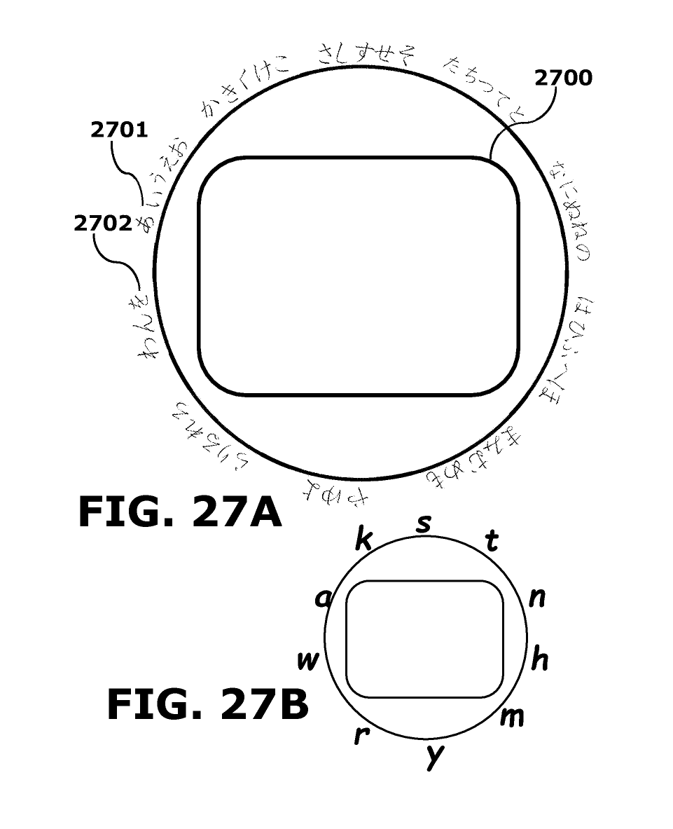

Japanese Hiragana and Katakana are like Devanagari script in that they are naturally presented as a table. Each row in the table represents a base sound, and the columns contain the symbols representing that base sound as variously modified, such as being combined with a vowel or accent. An example is the Gojūon (“50 sounds”) table for the Japanese Hiragana/Katakana symbols. Turning to FIG. 27A, we see a device according to the present teachings in which the 50 sounds table supplies an ordering of symbols in a keyboard, reading first across the top row of the table left to right to form a group, and then moving down to each subsequent row to form new groups, the groups arranged clockwise around the device. The device comprises a central region suitable for display [2700] and a keyboard [2701] with groups of symbols arrayed about the central display [2700]. Thus the Gojūon table is understood as a source of both ordering and grouping: the ordering as just described and a grouping by rows of the table. In FIG. 27A we represent this grouping by making the inter-group distance between symbols be larger than the intra-group distances between symbols, these distances in turn relate to enter and exit parameter ranges for crosspair swipe segments used to input symbols from each group. FIG. 27B supplies a Latin-script key for the arrangement of katakana in FIG. 27A. The independent vowels are in the group marked by the letter a and the other groups are marked by the initial consonant of the syllables in the group, k for the group ka, ki, ku, ke, ko, and so on for s, t, n, h, m, y, r, w, each letter corresponding to the consonant sound of a row of the Gojūon table. A similar key could be provided using the Hiragana/Katakana symbols themselves, using e.g. the first symbol of each group to represent and mark all the letters of a group. This, indeed, would be a useful way to mark these symbols on a clock face

Two further aspects of the illustrative arrangement of the symbols in FIG. 27A should be pointed out. First, not all of the groups have the same number of symbols; most have 5 symbols, but two have 3 symbols. Second, one of the groups of 3, the one marked “w” in FIG. 27B and [2702] in FIG. 27A, in fact contains a extra symbol outside of the main table, this symbol corresponds to the sound “n”. These aspects are examples of general tactics for dealing with grouping of symbols which may not fall neatly into even-sized groups. Such tactics are valuable in situations in which a symbol set has strong regularities, but also a variety of exceptions to the general scheme. For the sake of increased regularity, smaller groups can be merged and “extra” symbols can be dropped (especially if they are rarely used). These tactics were also used in the treatment of Devanagari script above. Japanese kana symbols may take diacritic marks (ten-ten and maru). Kana may be Hiragana or Katakana. These distinctions can be incorporated in the embodiment of FIGS. 27A-B using the techniques described above for Devanagari. Further, Hiragana symbols may be intended to exist as such, or to be later converted to Kangi. One could add an annular “hook” in one direction to indicate that the character should be represented as Katakana rather than Hiragana, and a hook in the other direction to indicate that the Hiragana is (part of) the pronunciation of a Kangi, that is, is a cHiragana in the terms of U.S. Pat. No. 8,200,865 (“Efficient method and apparatus for text entry based on trigger sequences”) hereby incorporated by reference. The annular hooks could continue with another crosspair swipe to add diacritic marks used in Japanese (comprising ten-ten and maru).

Predictive Completion of Crosspair Segments on Continuous Paths

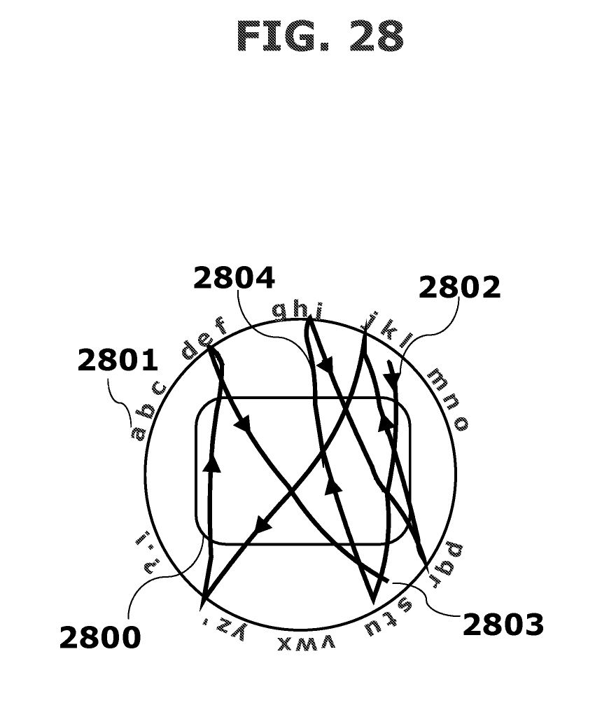

Through many embodiments we have compared and contrasted swipe-switches with crosspair swipe segments, and shown how both of these can work together. In this final embodiment, we consider the possibility that a user, being lazy, in a hurry, or simply a novice, may fail to fully complete crosspairs, though they intend to. They may be attempting to segment a long continuous swipe into crosspair segments so as to input an entire word with one swipe, for instance. To deal with these instances and more, we can include a prediction and correction module to transform the actual path taken by a user into a corrected path which accomplishes what they apparently intended. For instance a more-or-less straight segment of a swipe which almost but not quite reaches a boundary can be interpreted as one which does in fact reach the boundary. By extending the swipe to cross the boundary, the software can recover the users intent to cross the boundary from the actual swipe data. Further, rather than circling around the shape to find the next parameter region for an out-to-in cross, the user might shortcut across the interior of the shape, creating a spurious crosspair. That part of the swipe was meant simply for positioning, not to input a letter. Software might be used to identify those positioning segments and delete them before further processing. This is illustrated in FIG. 28 which comprises a display [2800] embedded in a keyboard substantially surrounding it [2801]. It also comprises hardware sensitive to swipes, and the relevant circuitry and software needed to register those swipes, parse them into crosspair segments and convert those segments into symbols to be displayed on the display [2800]. FIG. 28 shows a complicated continuous swipe, beginning at [2802] and continuing to [2803] which is intended to input the word “like”. The direction along the various segments of the swipe are indicated by arrowheads. Some of the segments are “real” in the sense that they are intended by the user to input one of the letters l, i, k, and e. Others segments, such as the segment [2804] are merely for positioning. In the case of [2804], the segment is for repositioning to enter the letter i after the letter l has been input. Software would be required to operate to parse the full swipe into crosspair segments and associate each crosspair segment with the output of symbol, if such were intended, or to classify the crosspair as merely positioning, that is intended to advance from one node to another along some edge, without the intent of outputting a symbol. Relevant software engineering techniques are known, e.g., in the art of handwriting recognition, or more generally, artificial intelligence.

It should be noted that swipe patterns created in this way, or an idealization thereto, may have value in their own right, without reference to graph navigation or an output, such as output of a sequence of symbol sequences. The graphic pattern produced in operating the device can be used as a graphic representation of the output, as a matter of communication or simply design. If the output in some implementation is a group of letters or words, the pattern could visually substitute for the text output. For example, the pattern could be a person's signature, or it could be used as a pattern for a tattoo, or drawn in the air as expression of greeting or other, used as a logo, an emoji and so on. Indeed, since these swipe patterns potentially constitute a new written language, sequences of such swipe patterns being read much like sequences of Chinese ideograms.

Having absorbed the forgoing it should now to appreciated by a person skilled in the art how to make many variations within the scope of the appended claims. We have mentioned for instance, that the shape involved could be flat, a line for 2-D systems, and a plane for 3-D systems. “Outside” the space could e.g. be above the line and “inside” could be below the line. Working through how such embodiments would work is left as an exercise for the attentive reader. Similarly, though we have concentrated on 2-D systems, extensions to 3-D systems are straightforward. Consider, for instance, the Earth represented as a globe in a virtual reality system, a sphere of a couple feet in diameter. We can build a geographic navigational system from this representation. To select a continent, one plunges one's hand through the sphere somewhere in the representation of the continent on the surface of the sphere. The image on the sphere now changes so that different patches represent different countries of that continent. Once can spin the sphere to find the desired country and then pull one's hand out through that representation to select the country. Plunging back in, perhaps in a continuous motion, one can then select a city in that country, neighborhoods in that city, streets in that neighborhood and so on, to as much detail as the designers of the system have provided, using just the human-computer interface technology described in detail above and within the scope of the appended claims.

What is claimed is:

1) A human-computer interface for navigating graphs comprising 1) a path generator for generating paths through n-dimensional space under direction of said human; 3) a shape of dimension m<=n through which said paths can traverse; 4) a parameterization of said shape; 5) a crossing detector which detects when paths generated by said path generator cross the surface of said shape by entering or exiting said shape, and computes the parameter values of the positions at which said entering or exiting occurs, said crossing detector generating electromagnetic signals representing detected crosses, communicating said signals for further graph navigation processing; 6) given a graph to be navigated by said human using said interface, said graph comprising nodes and edges connected said nodes, a mapping of each navigable node of said given graph to a first range of values in said parameterization, and a mapping of each navigable edge from said each navigable node to a second range of values of said parameterization, said second range contained completely within the complement of said first range of values in said parametrization; 7) a navigator, which receives signals from said crossing detector, and uses said signals to navigate said given graph in consultation of said mapping, such that when said crossing detector detects a crosspair, said crosspair being the entrance of said path in a region of said shape corresponding to said first range, followed by an exit of said path in said second range, with no intervening crosses detected by said crossing detector, then said navigator will navigate in said given graph from said node corresponding to said first range along said edge corresponding to said second range.

2) The human-computer interface of claim 1 further comprising an association of a plurality of said navigable edges each with a sequence of symbols, and further comprising an apparatus to output the sequence of said symbols associated to a given said navigable edge in said plurality of navigable edges when said given navigable edge is navigated by said human using said interface.

3) The human-computer interface for navigating graphs of claim 2 where said sequences of symbols comprise symbols used to write a human language.

4) The human-computer interface of claim 1 further comprising an auxiliary display for display of a representation of the current state of graph navigation.

5) The human-computer interface of claim 1 further comprising visual guidance to said human for efficiently creating a crosspair.

6) The human-computer interface of claim 5 where said visual guidance includes modification of font characteristics of text displayed in said auxiliary display as an actual path is traced by said human.

7) The human-computer interface of claim 1 further comprising an L-shaped swipe recognizer capable of recognizing a crosspair swipe segment immediately followed by a swipe-switch with an ideal path within an annulus.

8) The human-computer interface of claim 1 further comprising a T-shaped swipe recognizer capable of recognizing a crosspair swipe segment followed by a first swipe-switch with an ideal path within an annulus, then followed by a second swipe-switch with an ideal path within said annulus but oriented in the opposite direction along said annulus.

9) The human-computer interface of claim 3, such that as values increase in said parameterization labels for said symbols are placed along said shape so that said label placements piecewise increase or decreases in alphabetic order, by the order given by the rows or columns of a mechanical typewriter, or the rows or columns of a table conventionally presenting a script in tabular form.

10) The human-computer interface of claim 1 implemented in a device to be worn on the wrist.

11) The human-computer interface of claim 2 where said output symbols are displayed in a display contained within said shape.

12) The human-computer interface of claim 1 further comprising keys.

13) The human-computer interface of claim 1 further comprising swipe switches.

14) The human-computer interface of claim 9 where said symbols are placed at or near clock points.

15) The human-computer interface of claim 14, where said symbols include the letters a-z grouped by 3, such that the group abc is place near one clock point, def near another clock point clockwise from said one clock point, and so on up to a group containing the letter z.

16) An apparatus, which is a human-computer interface for navigating graphs comprising 1) a path generator for generating finite paths through 2-dimensional space under direction of said human; 2) a piece-wise continuous shape, the closure of which is conformally mappable to a circle 3) a parameterization of the closure of said shape; 4) a piecewise alphabetic or mechanical typewriter ordering of symbols around said shape, such that each piece Oᵢ of said piecewise ordering corresponds to a piece Pᵢ of said parameterization, which is in turn associated with a piece Sᵢ of said closure of said shape; 5) for each Oᵢ, at least one associated swipe-switch SSᵢⱼ whose ideal path begins at or near said associated Sᵢ and pointing towards the interior of said closure of said shape, each SSᵢⱼ associated with one or more symbols from Oᵢ; 6) a matching mechanism for matching actual swipes performed by said human to an ideal path of one of said SSᵢⱼ such that when said human performs a swipe W beginning at or near Sᵢ said matching mechanism will match W to a matched SSᵢⱼ associated to Si, and then said symbol or symbols associated to said matched SSᵢⱼ will be output.

17) The apparatus of claim 20, such that the plurality of all said SSᵢⱼ beginning at or near said shape S and pointing towards said interior of said shape S are sufficient to input all said letters of said alphabet, and further such that there are no swipe-switches whose ideal path begins in said interior of said shape S, and points toward or through the boundary of said shape S.

18) The apparatus of claim 20, such that said alphabetic ordering of letters contains the letters A through Z, said letters arranged in Oᵢ containing no more than 3 symbols each, and such that there is for each symbol in each Oᵢ a functionally distinct SSᵢⱼ 1<=j<=3, such that each symbol can be output unambiguously by said human by swiping nearly along the ideal path of the SSᵢⱼ corresponding to the symbol that said human intends to output such that said matching mechanism will match said nearly along swipe to said corresponding SSᵢⱼ causing said intended symbol to be output.

19) The human-computer interface of claim 15, where said group abc is placed at clockpoint 10, def at 11, ghi at 12, jkl at 1, mno at 2, backspace symbol at 3, pqr at 4, stu at 5, vwx at 6, yz′ at 7, ?.! at 8, space symbol at 9.

20) The human-computer interface of claim 15 when said second range of values corresponding to the letters in each said letter group follow around the shape such that gestures inputing letters from one group are the same as gestures input another group up to rotation around the center of the shape.
